(19) United States
(12) Patent Application Publication
(10) Pub. No.: US 2025/0265602 A1
(43) Pub. Date: Aug. 21, 2025

(54) METHODS AND SYSTEMS FOR GENERATING UPSTREAM CRADLE-TO-GATE PRODUCT CARBON FOOTPRINTS

(71) Applicant: Muir AI Inc., Seattle, WA (US)

(72) Inventors: Peter WILLIAMS, Seattle, WA (US); Harris CHALAT, Seattle, WA (US); Zhucheng ZHAN, Seattle, WA (US); Erika Marie ODMARK, Seattle, WA (US)

(73) Assignee: Muir AI Inc., Seattle, WA (US)

(21) Appl. No.: 19/054,724

(22) Filed: Feb. 14, 2025

Related U.S. Application Data
(60) Provisional application No. 63/554,095, filed on Feb. 15, 2024.

(51) Int. Cl. G06Q 30/018; G06Q 10/0831; G06Q 10/0834

(52) U.S. Cl. CPC G06Q 30/018; G06Q 10/0831; G06Q 10/08345

(57) ABSTRACT

Methods of generating upstream cradle-to-gate carbon footprints for physical products based on minimal user inputs, and associated systems and devices are disclosed herein. In some embodiments, a representative method of generating a carbon footprint for a product to be manufactured at a source location and transported to a destination location includes decomposing the product into constituent materials, components, and/or processes. The method can further include matching the constituent materials, components, and/or processes to at least one database of emission factors, and extracting the emissions factors for the constituent materials, components, and/or processes. The method can further include generating a probabilistic supply chain mapping of the constituent materials and/or components from upstream source locations to the source location, and adjusting the emissions factors based on the probabilistic supply chain mapping. Finally, the method can include aggregating the adjusted emissions factors to generate an emissions output for the product.

### CROSS-REFERENCE TO RELATED APPLICATION

This application claims the benefit of U.S. Provisional Patent Application No. 63/554,095, filed Feb. 15, 2024, and titled “METHODS AND SYSTEMS FOR GENERATING UPSTREAM CRADLE-TO-GATE PRODUCT CARBON FOOTPRINTS,” which is incorporated herein by reference in its entirety.

### TECHNICAL FIELD

The present technology generally relates to methods and systems for generating upstream cradle-to-gate carbon footprints for requested products based on minimal user inputs.

### BACKGROUND

According to the Intergovernmental Panel on Climate Change (IPCC), the accumulation of carbon dioxide (CO₂) in the atmosphere is the main driver of global warming. Current trends project that in the year 2100 the atmospheric CO₂ concentration will be between 530-980 parts per million (ppm)—possibly doubling the current level of 410 ppm and far higher than the preindustrial level of 280 ppm. The rising CO₂ concentration could cause a global mean temperature change from 1990 to 2100 of 1.4-6.1 degrees Celsius. CO₂ emissions must be reduced to avoid or mitigate the effects of global warming.

One source of significant CO₂ emissions is the manufacturing and shipping of physical products, such as consumer goods. However, it can be difficult for organizations (e.g., companies) to accurately determine the CO₂ emissions for a given product procured from their supply chain, which may have components manufactured and transported around the world. For example, the aggregate CO₂ emissions of a physical product manufactured in China and shipped to a company in the United States may be higher than the CO₂ emissions if the same product were manufactured and shipped from Vietnam due to variations in the energy sources used to manufacture the product, variations in where raw materials for the product are sourced from, the method and path of transport of the manufactured product to the organization, etc. If organizations were able to accurately view the carbon footprint of their products, they may be able to make informed decisions to reduce CO₂ emissions by, for example, changing the source location of the product.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 is a block diagram of a carbon emissions modeling software platform in accordance with embodiments of the present technology.

FIG. 2 is a block diagram of a carbon emissions intelligence platform of the carbon emissions modeling software platform of FIG. 1 in accordance with embodiments of the present technology.

FIGS. 3A-3D are schematic views of various processing steps of the carbon emissions intelligence platform of FIG. 2 for a specific product input in accordance with embodiments of the present technology.

FIG. 4 is a block diagram of a process or method that can be carried out by a product decomposer of the carbon emissions intelligence platform of FIG. 2 to decompose a product into its components, materials, and/or manufacturing processes in accordance with embodiments of the present technology.

FIG. 5 is a block diagram of a process or method that can be carried out by a supply chain mapper of the carbon emissions intelligence platform of FIG. 2 to model likely trade countries for various materials and components of the product in accordance with embodiments of the present technology.

FIG. 6A is a flow diagram of a method or process for identifying a closest match for each of the components, materials, and/or manufacturing processes of the product in an emissions factors database and extracting fuel and electricity usage for each of the components, materials, and/or manufacturing processes in accordance with embodiments of the present technology.

FIG. 6B is a flow diagram of a method or process for identifying a closest match for each of the components, materials, and/or manufacturing processes of the product in an emissions factors database and extracting fuel and electricity usage for each of the components, materials, and/or manufacturing processes in accordance with embodiments of the present technology.

FIG. 7 is a block diagram of a process or method that can be carried out by a transport emissions estimator of the carbon emissions intelligence platform of FIG. 2 to estimate emissions factors for various transportation steps of the product in accordance with embodiments of the present technology.

FIGS. 8A-8D are screenshots of different portions, pages, and/or displays of a user interface of a user application of the carbon emissions modeling software platform of FIG. 1 in accordance with embodiments of the present technology.

FIG. 9A illustrates product inputs that can be input into and analyzed by the carbon emissions modeling software platform of FIG. 1 to generate one or more carbon footprint emissions reports in accordance with embodiments of the present technology.

FIGS. 9B-9E are screenshots of different portions, pages, and/or displays of a user interface of the user application of the carbon emissions modeling software platform of FIG. 1 and displaying various emissions reports for the product inputs of FIG. 9A in accordance with embodiments of the present technology.

FIG. 10 is a screenshot of a portion, a page, and/or a display of a user interface of the user application of the carbon emissions modeling software platform of FIG. 1 in accordance with embodiments of the present technology.

FIG. 11 is a schematic view of an additional or alternative decomposition of an example Henley t-shirt product in accordance with embodiments of the present technology.

FIG. 12 is a block diagram of a product intelligence platform in accordance with embodiments of the present technology.

FIG. 13 is a block diagram that illustrates an example of a computer system in which at least some operations described herein can be implemented in accordance with embodiments of the present technology.

FIG. 14 is a block diagram of an example transformer.

FIG. 15 is a block diagram illustrating an architecture for large language model applications, according to some implementations.

Aspects of the present technology described herein will become more apparent to those skilled in the art by studying the Detailed Description in conjunction with the drawings. Embodiments or implementations describing aspects of the present technology are illustrated by way of example, and the same references can indicate similar elements. While the drawings depict various implementations for the purpose of illustration, those skilled in the art will recognize that alternative implementations can be employed without departing from the principles of the present technology. Accordingly, while specific implementations are shown in the drawings, the present technology is amenable to various modifications.

### DETAILED DESCRIPTION

Aspects of the present technology are directed generally to methods of generating upstream cradle-to-gate carbon footprints for physical products based on minimal user inputs, and associated systems and devices. In some embodiments, a representative method of generating a carbon footprint for a product to be manufactured at a source location and transported to a destination location includes decomposing the product into constituent materials, components, and/or processes. The method can further include matching the constituent materials, components, and/or processes to at least one database of emission factors, and extracting the emissions factors for the constituent materials, components, and/or processes. The method can further include generating a probabilistic supply chain mapping of the constituent materials and/or components from upstream source locations to the source location, and adjusting the emissions factors based on the probabilistic supply chain mapping. Finally, the method can include aggregating the adjusted emissions factors to generate an emissions output for the product.

In some aspects of the present technology, the output of the method is a probabilistic graph model that consists of nodes representing manufacturing, processing, and/or production steps and links that represent the transport between different steps. Each node has associated data about the component/material being produced at that step and the mass, the emissions factor of the step, the energy inputs and process emissions of the step, the total emissions based on the mass, and the relative weight of the node. Each link has associated data about the source location, destination location, component/material and mass being transported, the emissions factor of the link, the total emissions based on the mass, the transportation modes and distances, and the relative weight of the link. This information can be presented in various forms at a user application.

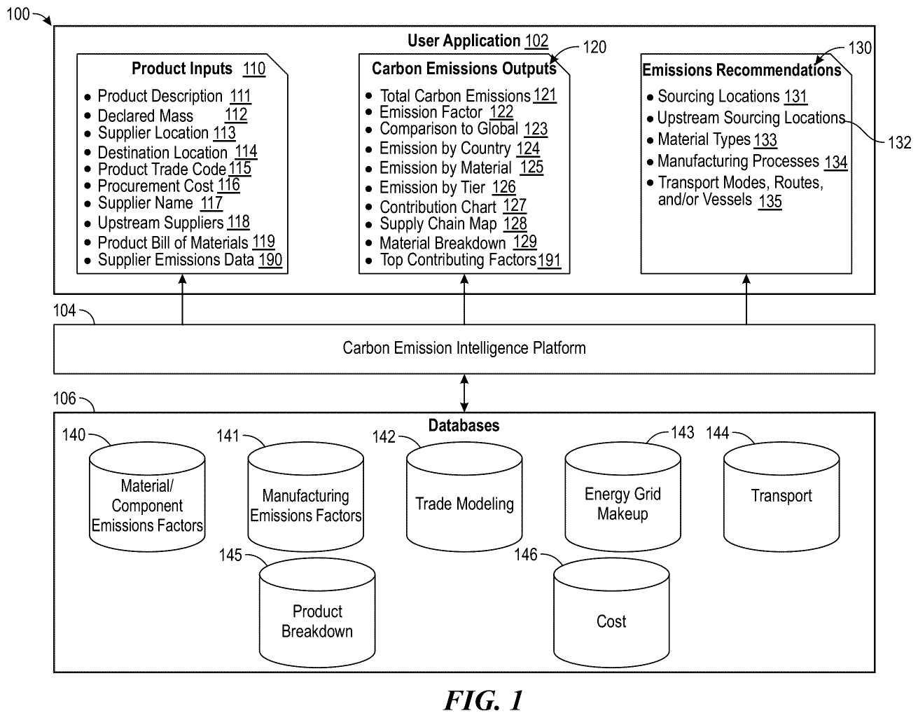

Specific details of several embodiments of the present technology are described herein with reference to FIGS. 1-15. The present technology, however, can be practiced without some of these specific details. In some instances, well-known structures and techniques often associated with machine learning processes, large language models, user interfaces, computing systems, and the like have not been shown in detail so as not to obscure the present technology.

The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The description and associated drawings are illustrative examples and are not to be construed as limiting. This disclosure provides certain details for a thorough understanding and enabling description of these examples. One skilled in the relevant technology will understand, however, that the present technology can be practiced without many of these details. Likewise, one skilled in the relevant technology will understand that the invention can include well-known structures or features that are not shown or described in detail, to avoid unnecessarily obscuring the description of the present technology.

The headings provided herein are for convenience only and should not be construed as limiting the subject matter disclosed. To the extent any materials incorporated herein by reference conflict with the present disclosure, the present disclosure controls.

### I. SELECTED EMBODIMENTS OF CARBON EMISSIONS MODELING SYSTEMS AND METHODS

FIG. 1 is a block diagram of a carbon emissions modeling software platform 100 (“platform 100”) in accordance with embodiments of the present technology. In the illustrated embodiment, the platform 100 includes a user application 102, a carbon emissions intelligence platform 104 (which can also be referred to as a product intelligence platform and/or the like), and a plurality of databases 106. The user application 102, the carbon emissions intelligence platform 104, and the databases 106 are in communication with each other via a network. In some embodiments, the user application 102 is a cross-platform software application configured to work on several computing platforms and web browsers and/or an application programming interface (API).

The user application 102 can include a user interface for receiving product inputs 110, displaying carbon emissions outputs 120 associated with the product inputs 110 and generated by the carbon emissions intelligence platform 104, and displaying emissions recommendations 130 generated by the carbon emissions intelligence platform 104. In general, the product inputs 110 can specify details of a physical product that a company (e.g., a customer) (i) is procuring or is interested in procuring from a supplier (e.g., a source) from their supply chain or that (ii) they as a company make in a facility under their control. The product can be a manufactured item (e.g., a T-shirt, a circuit board, an athletic shoe, a chemical) or a raw material. As used herein, “product” encompasses both manufactured items and raw materials. Typically, the company is positioned at a destination location (e.g., a physical location of the company), the supplier is positioned at a different supplier/source location (e.g., a physical location in a different country), and the product is to be manufactured at the supplier location and transported to the destination location. The product inputs 110 can comprise text, images, and/or other information that are input into the user application 102 via a user input device, such as a keyboard, mouse, voice-to-text device, etc.

More specifically, the product inputs 110 can include a product description 111, a declared mass 112, a supplier location 113 (e.g., a source location), a destination location 114 (e.g., a receipt location), a product trade code 115, a procurement cost 116, a supplier name 117, one or more upstream suppliers 118, a product bill of materials (BOM) 119, and/or supplier emissions data 190. The product description 111 can comprise text, images, and/or other information specifying a product (e.g., the text “t-shirt,” “Henley t-shirt,” “circuit board,” “athletic shoe,” “alkaline battery,” an image of a-shirt, an image of a Henley t-shirt, an image of a circuit board, an image of an athletic shoe, an image of an alkaline battery, etc.). The declared mass 112 can comprise a discrete item amount or an amount of the product to be procured from the supplier. The destination location 114 can comprise the ultimate shipping destination for the product, such as a location of the company to which the product will be shipped from the supplier (e.g., a location of the company's control gate). The product trade code 115 can comprise a Harmonized System (HS) code, a Harmonized Tariff Schedule (HTS) code, and/or the like that provides a standardized numerical classification of the specified product. The procurement cost 116 can comprise the cost to order the product from the supplier and ship the product to the destination location. The supplier name 117 can identify the supplier and/or a specific location of the supplier. The upstream suppliers 118 can comprise one or more suppliers upstream from the supplier that will supply various components, materials, etc., to the supplier (e.g., to the supplier location 113) for use in manufacturing the product. More generally, the upstream suppliers 118 can comprise one or more upstream supplying countries that will supply various components, materials, etc., to the supplier for use in the manufacturing the product (e.g., upstream supplier countries rather than specific upstream supplier locations within a country). The product BoM 119 can comprise a structured list identifying all or some materials and components and their amounts required to manufacture the product and/or instructions for procuring and using the materials and components. The supplier emissions data 190 can comprise actual reported emissions from a supplier of the manufacturing emissions of one or more manufacturing steps to manufacture the product.

In some embodiments, to generate the emissions outputs 120, the carbon emissions intelligence platform 104 requires input of one or more of the products inputs 110. For example, in some embodiments the product description 111, the declared mass 112, the supplier location 113, and the destination location 114 are required, while the rest of the product inputs 115-119 are optional. The optional product inputs 115-119 can further refine the emissions outputs 120. In some embodiments, the carbon emissions intelligence platform 104 requires input of one or both of the product description 111 and the product BoM 119. In some embodiments, the declared mass 112 is optional, and the carbon emissions intelligence platform 104 can return the carbon emissions outputs 120 on a per unit of mass basis.

The carbon emissions intelligence platform 104 can receive some or all of the product inputs 110 and utilize one or more artificial intelligence (AI) applications (e.g., machine learning (ML) models) to model the carbon emissions from the extraction of the raw materials used in the product (e.g., “cradle”) to the point where the product enters or exits the company's control (e.g., “gate”). While reference is generally made herein to emissions of carbon (e.g., carbon dioxide), the emissions intelligence platform 104 can be utilized to analyze and generate emissions outputs for other chemicals (e.g., greenhouse gases (GHGs), pollutants, etc.) and other product attributes (e.g., cost). For example, the carbon emissions intelligence platform 104 can model carbon dioxide equivalence (CO₂e), which considers all GHGs and converts their impact to global warming potential (GWP) in terms of carbon dioxide (e.g., equivalence to carbon dioxide's global warming potential over 100 years, GWP100). Sometimes, the various processes carried out by the supplier to manufacture the product are not under the financial or operational control of the company receiving the product. Therefore, the receiving company cannot directly measure site-specific carbon emissions for the various manufacturing steps. Accordingly, the carbon emissions intelligence platform 104 can model the upstream cradle-to-gate carbon emissions using various datasets stored in the databases 106.

More specifically, the databases 106 can comprise one or more material/component emissions factors databases 140, one or more manufacturing emissions factors databases 141, one or more trade modeling databases 142, one or more energy grid makeup databases 143, one or more transport databases 144, one or more product breakdown databases 145, one or more cost databases 146, and/or additional databases. The emissions factors databases 140 can store a dataset of emissions factors, emissions associated with energy inputs (e.g., electricity, fuel, etc.), emissions associated with process outputs (e.g., from chemical reactions, etc.), and/or the like for different materials and components that may be used in a product. An emissions factor is a representative value that relates the quantity of carbon dioxide or other pollutant released to the atmosphere with an activity associated with the different materials and components. As a specific example, the emissions factors databases 140 can store an emissions factor (e.g., a quantity of carbon dioxide released per unit mass (e.g., 1 kg)) for polyester resin, energy inputs for producing polyester resin, and/or process emissions output from the production process. The emissions factor can aggregate emissions generated from the production of the raw materials used to produce the polyester resin (e.g., acetic anhydride, adipic acid, etc.), from the processes used to transform the raw materials into polyester resin, etc. In some embodiments, the emissions factor comprises a carbon dioxide equivalence (CO₂e) value that considers all GHG emissions for the product (e.g., polyester resin) and converts their impact to GWP in terms of carbon dioxide. In particular, the emissions factors database 140 can include specific values for the electricity and fuel utilized to produce the polyester resin. Such values are typically averaged globally and/or regionally to account for different carbon emissions in generating electricity and burning fuel. For example, utilizing green power sources (e.g., nuclear power, solar power, wind power) will generally produce no or far fewer carbon emissions than generating electricity via burning coal and/or other fossil fuels. In some embodiments, the emissions factors databases 140 include data generated by the ecoinvent Association of Technopark, Technoparkstrasse 1, 8005 Zürich, Switzerland and available in the ecoinvent database (available at https://ecoinvent.org/). In some embodiments, the emissions factors databases 140 can store an uncertainty (e.g., an uncertainty distribution) associated with each of the emission factors, energy inputs, process outputs, and/or other entries. The uncertainty can be sampled for a particular entry as described in greater detail below to determine an uncertainty and/or confidence interval for the entry.

The manufacturing emissions factors databases 141 can store a dataset of manufacturing emissions factors that specify the energy (e.g., electricity and fuel) intensity and emissions generated directly from the process (e.g., from the chemical reaction) of different manufacturing processes that may be used to manufacture a product. Such a dataset can be built and updated using specific customer data (e.g., emissions factors or energy specified by a company utilizing the platform 100) and integrated into a customer data platform (CDP), by scraping the open-source openLCA database (available at https://www.openlca.org/) to extract manufacturing energy intensities for various materials and components, and/or by extracting process-level energy inputs from material/component emission factor databases (e.g., the emissions factors database 140) to gain manufacturing inputs. In some embodiments, the data in the manufacturing emissions factors database 141 includes the manufacturing process name and description and/or industry classification codes, such as North American Industry Classification System (NAICS) codes. The manufacturing process information can be linked to corresponding emissions factors for the specified industrial activity. The manufacturing emissions factors databases 141 can store multiple emissions factors (e.g., entries) for a particular manufacturing process.

The trade modeling databases 142 can store a dataset of bilateral trade flows for different materials and components that may be used in a product. In some embodiments, the trade modeling databases 142 include data generated by the Centre d'Etudes Prospectives et d'Informations Internationales (CEPII) and available the in BACI database (available at http://www.cepii.fr/CEPII/en/bdd_modele/bdd_modele_item.asp?id=37). The data can specify an HS code (e.g., 2-6-digits) or other product trade code for each material and component. In some embodiments, the trade modeling databases 142 includes data from the United Nations Commodity Trade Statistics Database (“ComTrade”; available at https://comtrade.un.org/), which details the trade (e.g., export, import, etc.) of different commodities between countries based on HS code.

The energy grid makeup databases 143 can store a dataset of energy grid makeups by country for electricity and energy grids. A grid makeup provides a breakdown of electricity generation by energy source for a particular country. For example, the grid makeups can breakdown electricity generation on a per-country basis by fossil fuels (e.g., natural gas, coal, petroleum, etc.), nuclear, renewables, (e.g., wind, hydropower, solar, etc.). The grid makeups can be historical (e.g., past looking) and/or predictive (e.g., forward looking). In some embodiments, the grid makeup databases include data generated by the U.S. Energy Information Administration (EIA) and available in the open EIA database (available at https://www.eia.gov/opendata/) and/or data generated by the International Energy Agency (IEA) and stored in the open IEA database (available at https://www.iea.org/data-and-statistics).

The transport databases 144 can store a dataset of global transportation information related to the global transport of products. For example, the transport databases 144 can store data specifying major ports and port-to-port connectedness and/or information on the shortest shipping routes between two locations. In some embodiments, the transport databases 144 store data on the shortest shipping routes (e.g., sea routes) between two locations generated by the Sea Route python package (available at https://pypi.org/project/searoute/). The transport databases 144 can store data on the emissions factors of various modes of transportation (e.g., sea, air, road, rail), such as emissions factors generated by the United States Environmental Protection Agency (EPA) (available at https://www.epa.gov/climateleadership/ghg-emission-factors-hub). Additionally, the transport databases 144 can store data on the most likely transport modes for certain commodities and their source and destination locations.

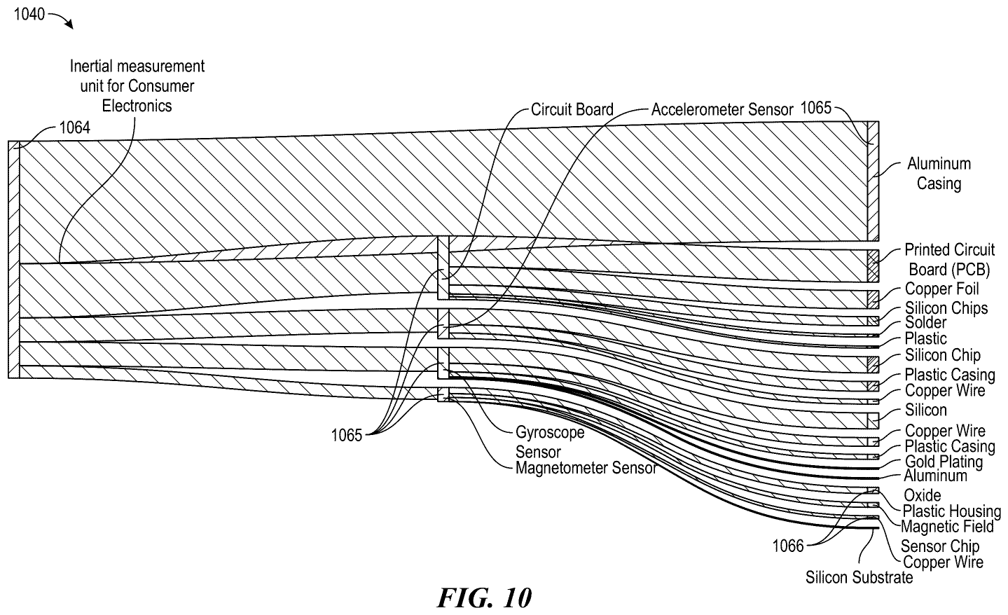

The product breakdown databases 145 can store a dataset of physical product decomposition information. The product breakdown databases 145 can store data specifying the breakdown of a component into the physical inputs, which could be materials or components, that are used in its preceding manufacturing process. Additionally, the product breakdown databases 145 can store data specifying the amount of each component or material that is used in the manufacturing process to create the final product. Such a dataset can be built and updated using specific customer data (e.g., bill of materials specified by a company utilizing the platform 100) and integrated into a customer data platform (CDP), by scraping open-source bill of materials from the web to extract product decomposition information, and/or by utilizing datasets that contain product decomposition information (e.g., ecoinvent). For example, FIG. 10, which is described in further detail below, is a screenshot of a portion, a page, and/or a display of a user interface of the user application 102 of the platform 100 of FIG. 1 in accordance with embodiments of the present technology and that shows product decomposition information that can be generated utilizing, in part, the product breakdown databases 145.

The cost databases 146 can store a dataset of component, material, energy, labor, and/or value add costs on a normalized unit basis. For example, the cost databases can store data specifying the component cost on a per-kilogram basis, or the energy cost on a per kilowatt hour or megajoule basis, or the labor cost on a per work-hour basis. Additionally, the cost databases 146 can store data on a regional basis, accounting for cost differences between different states, countries, and/or regions.

The databases 106 can be periodically updated (e.g., annually, biyearly, monthly, or more frequently) with new data. In some embodiments, the carbon emissions intelligence platform 104 can directly provide data from one or more of the databases 140 related to the product inputs to the user application 102. For example, data from the material/component emissions factors databases 140 can be provided to the user application 102.

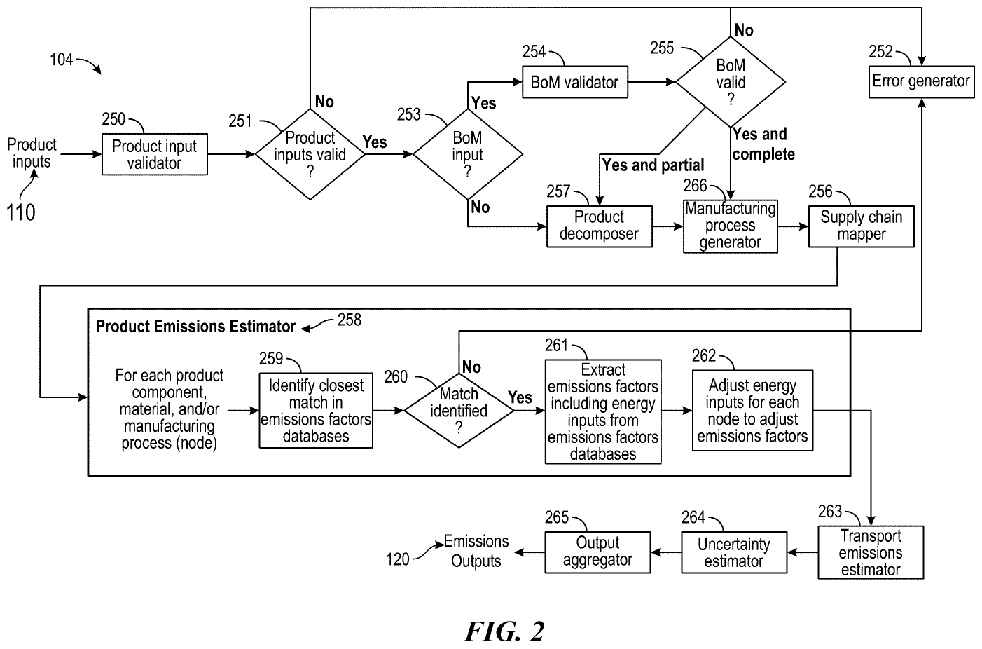

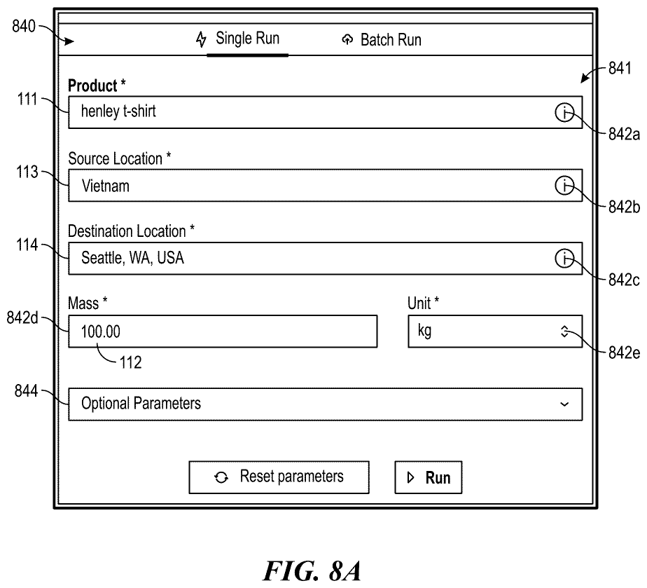

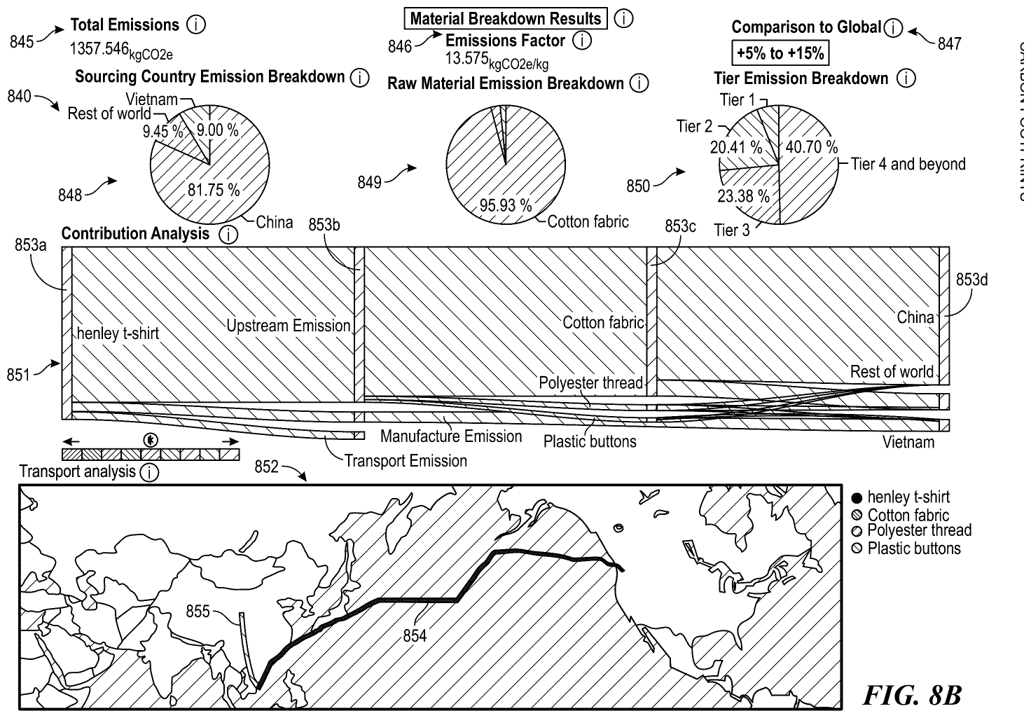

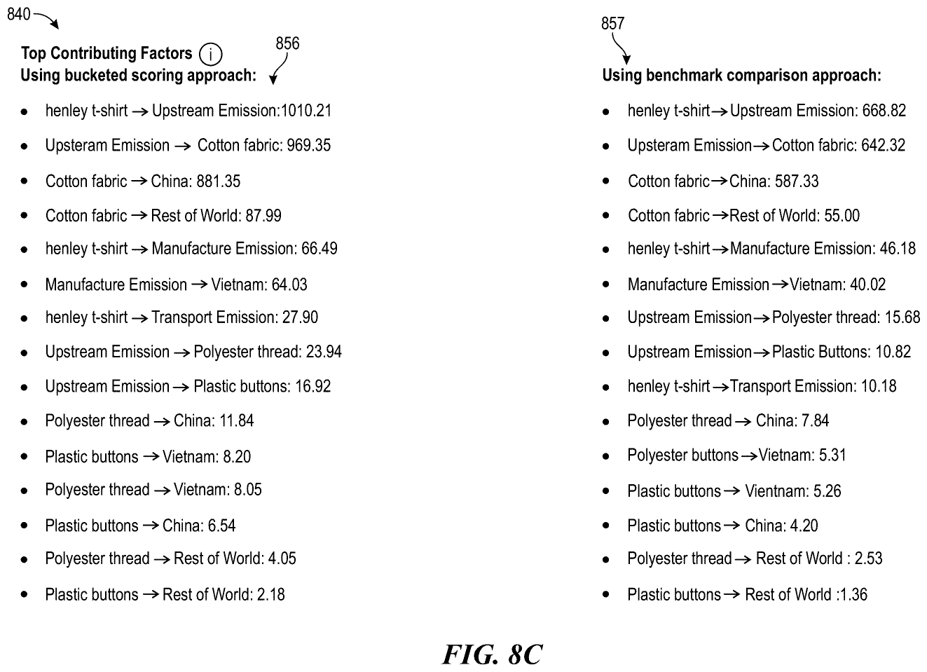

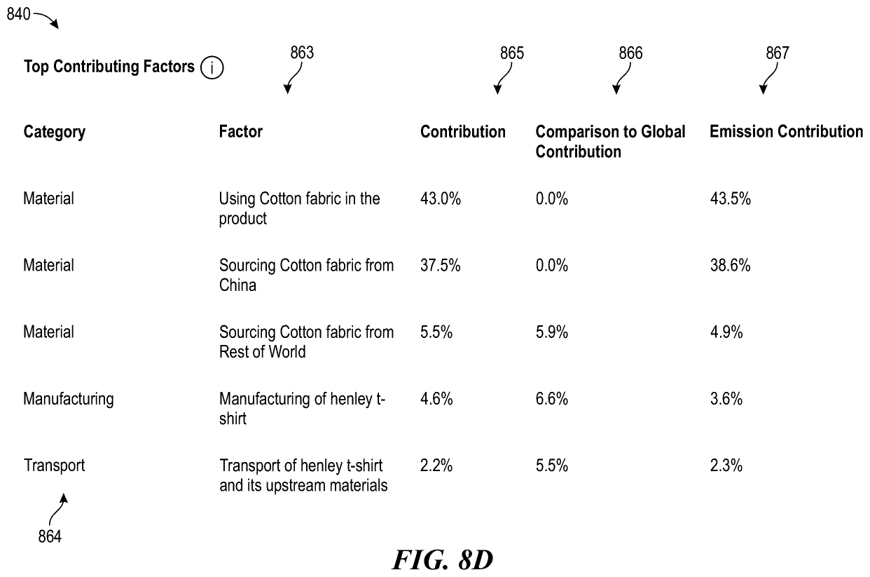

As described in greater detail below with reference to FIGS. 2-10, the carbon emissions intelligence platform 104 can utilize data from the databases 106, the product inputs 110, and one or more AI applications to (i) model the cradle-to-gate carbon emissions for a product specified by the product inputs 110 and (ii) generate the associated carbon emissions outputs 120 for display at the user application 102. The carbon emissions outputs 120 can comprise total carbon emissions 121, an emissions factor 122, a comparison to global 123, an emission by country 124, an emission by material 125, an emission by tier 126, a contribution chart 127, a supply chain map 128, a material breakdown 129, top contributing factors 191, and/or the like. Such carbon emissions outputs 120 can be presented at the user application 102 as text, lists, graphs, flow charts, and/or other visual indicators, and are described in greater detail below with reference to FIGS. 8A-10.

The carbon emissions intelligence platform 104 can further utilize data from the databases 106, the product inputs 110, and one or more AI applications to generate the emissions recommendations 130. The emissions recommendations 130 can comprise recommendations for changing some or all of the product inputs 110 and/or other aspects of a specified product to reduce carbon emissions. More specifically, the emissions recommendations 130 can comprise (i) one or more sourcing locations 131 (e.g., a particular supplier, supplier location) that, if utilized in the supply chain, would reduce carbon emissions, (ii) one or more upstream sourcing locations 132 (e.g., one or more upstream suppliers, upstream supplier locations) that, if utilized in the supply chain, would reduce carbon emissions, (iii) one or more material types 133 that, if utilized in the product, would reduce carbon emissions, (iv) one or more manufacturing processes 134 that, if utilized to manufacture the product, would reduce carbon emissions, and/or (v) one or more transport modes, routes, or vessels 135 that, if utilized to transport the product and/or its materials and components, would reduce carbon emissions. Such emissions recommendations 130 can be presented at the user application 102 as text, lists, graphs, flow charts, and/or other visual indicators, and are described in greater detail below with reference to Table 1.

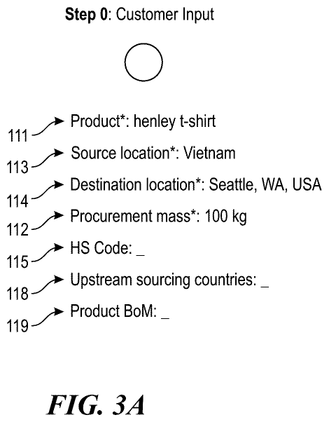

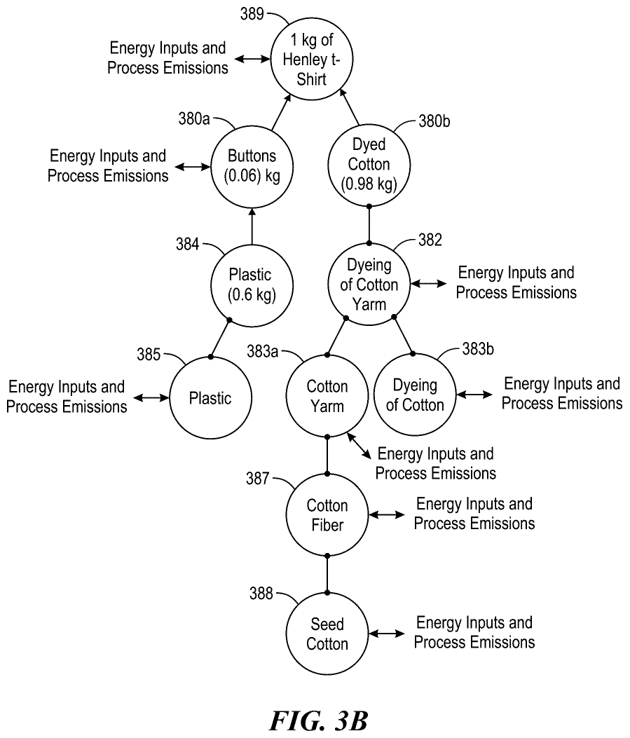

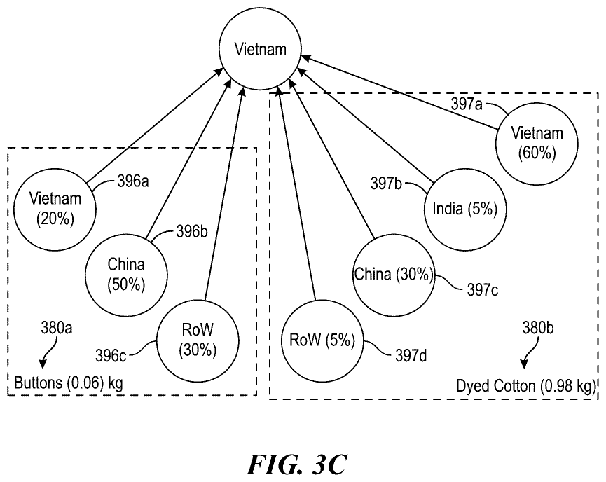

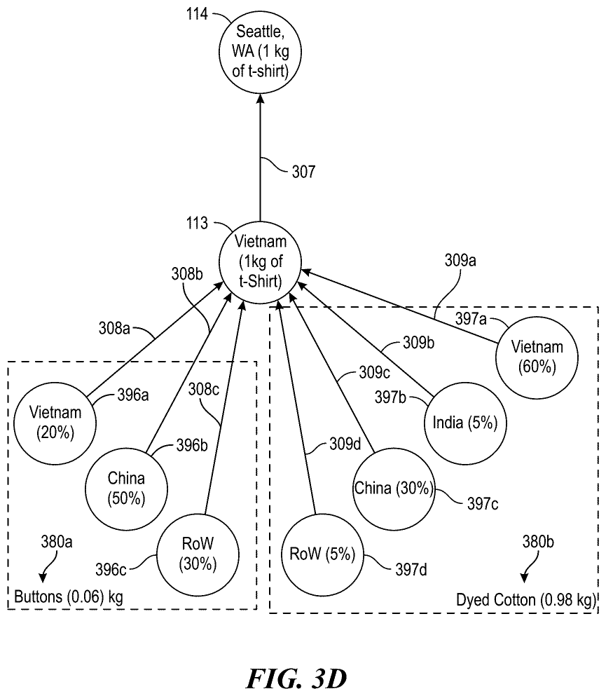

FIG. 2 is a block diagram of the carbon emissions intelligence platform 104 of FIG. 1 in accordance with embodiments of the present technology. FIGS. 3A-3D are schematic views of various processing steps of the carbon emissions intelligence platform 104 for a specific product input, such as a Henley T-shirt, in accordance with embodiments of the present technology. Referring to FIG. 2, the carbon emissions intelligence platform 104 can include a product input validator 250 that receives the product inputs 110. Referring to FIG. 3A, the product inputs 110 can include the product description 111 (a “Henley t-shirt”), the source location 113 (e.g., the location of the supplier; “Vietnam”), the destination location 114 (e.g., the destination of the customer; “Seattle, WA, USA”), and the declared mass 112 (“100 kg”). In the illustrated embodiment, the product trade code 115 (e.g., an HS code), the upstream suppliers 118 (e.g., upstream sourcing countries), and the product BOM 119 are not specified in the product inputs 110.

Referring to FIG. 2, the product input validator 250 can, at block 251, ensure that the product inputs 110 are valid—that is, interpretable to a real product and not gibberish or unintelligible. If the product inputs 110 are not valid (“no”), an error generator 252 of the carbon emissions intelligence platform 104 can generate an error message, such as for display at the user application 102 (FIG. 1). If the product inputs 110 are valid (“yes”), the product input validator 250 can, at block 253, determine if the product inputs 110 include a bill of materials (e.g., the product BoM 119 of FIGS. 1 and 3A).

If the product inputs 110 include a BoM, a BoM validator 254 of the carbon emissions intelligence platform 104 can determine if the BoM is valid at block 255. The BoM is a hierarchical structure of the components and materials and amounts thereof that make up a product. The BoM could include multiple layers of product breakdown. Accordingly, the BoM validator 254 can determine if the BoM is interpretable to the specified product. Likewise, the BoM validator 254 can determine if BoM is full or partial (e.g., specifying some but not all of the components, materials, processes, and/or amounts of the product). If the BoM is not valid (“no”), the error generator 252 can generate an error message, such as for display at the user application 102 (FIG. 1). If the BoM is valid and only partial (“yes and partial”), the BoM validator can provide the unspecified portions of the product to a product decomposer 257 of the carbon emissions intelligence platform 104. If the BOM is full and valid (“yes and complete”), the BoM validator 254 can provide the product components and materials specified to by the BoM to a manufacturing process generator 266 of the carbon emissions intelligence platform 104.

If the product inputs 110 do not include a BoM or include only a partial BOM, the product decomposer 257 can decompose the product inputs 110 into individual product components, materials, and/or manufacturing processes for input to the supply chain mapper 256. The product decomposer 257 can utilize an AI application to decompose the product specified by the product inputs 110 into its components, materials, and/or manufacturing processes-essentially automatically generating a BoM or a portion of a BoM for the product. The product decomposer 257 can utilize the product breakdown database 145 (FIG. 1) to search for products that are similar to the input product, subsequently using the retrieved information for the product breakdown.

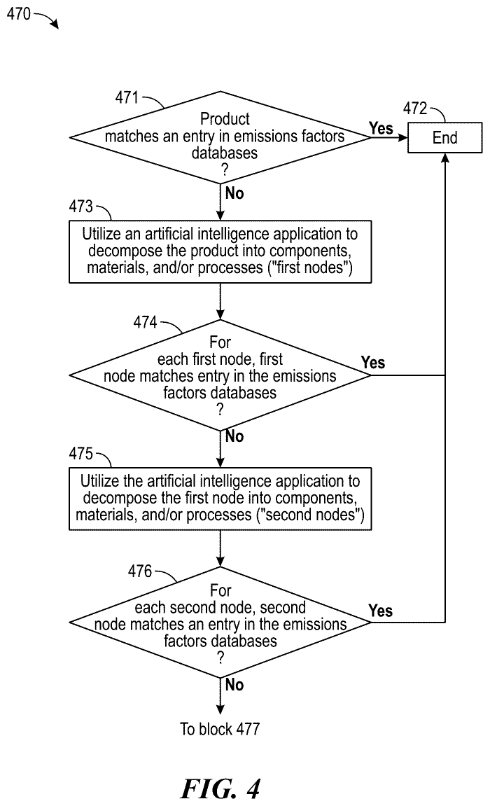

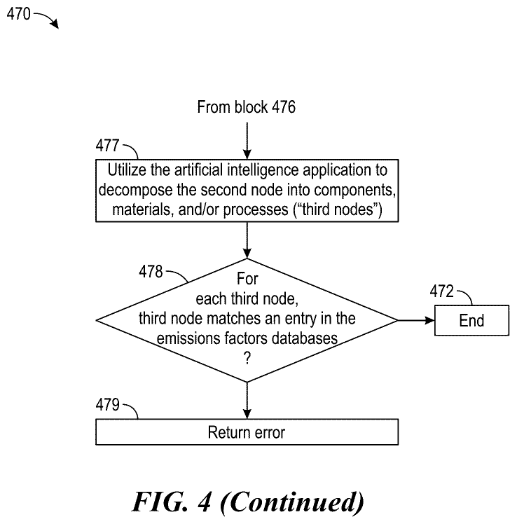

More specifically, FIG. 4 is a block diagram of a process or method 470 that can be carried out by the product decomposer 257 to decompose the product specified by the product inputs 110 into its components, materials, and/or manufacturing processes in accordance with embodiments of the present technology. In the illustrated embodiment, at block 471 the method 470 can include determining whether the product matches an emissions factor in an emissions factor database, such as the material/component emissions factors database 140 and/or the manufacturing emissions factors database 141 of FIG. 1. For example, if the product comprises raw material, the product may match an entry in the emissions factors database. If the product matches an entry, the method 470 can proceed to end at block 472. In some embodiments, block 471 of the method 470 can additionally or alternatively include determining whether the product specified by the product inputs 110 matches a product in the product breakdown database 145 of FIG. 1. If the product matches an entry in the product breakdown database 145, the method 470 can proceed to end at block 472.

If the product does not match an entry in the emissions factors databases, the method 470 can proceed to block 473 to utilize an artificial intelligence (AI) application (e.g., a generative AI application, a generative AI model, a large language model (LLM), a retrieval-augmented generation (RAG) model, and/or the like) to decompose the product into its components, materials, and/or manufacturing processes, which can be referred to as first nodes. For example, the AI application can be a generative AI application in which a text prompt can be input to decompose the product into its components, materials, and/or manufacturing processes, and/or the AI application can be a RAG application in which information about the product breakdown is retrieved from a product breakdown database (e.g., the product breakdown database 145 of FIG. 1). At block 474, for each first node, the method 470 can determine whether the first node matches an entry in the emissions factors database (e.g., the material/component emissions factors database 140 and/or the manufacturing emissions factors database 141 of FIG. 1). If the first node matches an entry in the emissions factors database, the method 470 can proceed to block 472 to end further processing for that first node.

If one or more of the first nodes do not match an entry in the emissions factors databases, the method 470 can proceed to block 475 to utilize the AI application to decompose the first node into its components, materials, and/or manufacturing processes, which can be referred to as second nodes. For example, a text prompt can be input into the AI application to decompose the first node into its components, materials, and/or manufacturing processes. At block 476, for each second node, the method 470 can determine whether the second node matches an entry in the emissions factors database (e.g., the material/component emissions factors database 140 and/or the manufacturing emissions factors database 141 of FIG. 1). If the second node matches an entry in the emissions factors database, the method 470 can proceed to block 472 to end further processing for that second node.

If one or more of the second nodes do not match an entry in the emissions factors databases, the method 470 can proceed to block 476 to utilize the AI application to decompose the second node into its components, materials, and/or manufacturing processes, which can be referred to as third nodes. For example, a text prompt can be input into the AI application to decompose the second node into its components, materials, and/or manufacturing processes. At block 478, for each third node, the method 470 can determine whether the second node matches an entry in the emissions factors database (e.g., the material/component emissions factors database 140 and/or the manufacturing emissions factors database 141 of FIG. 1). If the third node matches an entry in the emissions factors database, the method 470 can proceed to block 472 to end further processing for that second node.

If one or more of the third nodes do not match an entry in the emissions factors databases, the method 470 can proceed to block 479 to return an error message. Alternatively, the method 470 can continue in an iterative/recursive fashion to successively decompose any unmatched third nodes utilizing the AI application into their components, materials, and/or manufacturing processes, which can be referred to as fourth nodes, and to check for matches of the fourth nodes to entries in the emissions factors databases. In general, the method 470 can decompose the product into as many levels of nodes (e.g., three, four, or more) as needed until all the nodes are matched to entries in the emissions factors database. In some embodiments, the emissions factors databases are embedded (e.g., vectorized) into the AI application to allow for direct lookups. In some embodiments, the product breakdown databases are embedded (e.g., vectorized) into the AI application to allow for direct lookups.

FIG. 3B shows a schematic view of a decomposition of the example Henley T-shirt product in accordance with the method 470 of FIG. 4. Referring to FIGS. 3B and 4, at block 471 the Henley T-shirt product does not match an entry in the emissions factors database. Accordingly, at block 473 the AI application can decompose the Henley T-Shirt into first nodes 380 (including individually identified first nodes 380a and 380b) of components, materials, and/or manufacturing processes. The first node 380a comprises “buttons” and the second node 380b comprises “dyed cotton.” In some embodiments, the product is associated with a declared unit or quantity, such as 1 kilogram. Accordingly, the first nodes 380a-b can include a quantity associated therewith, such as 0.06 kg of buttons and 0.98 kg of dyed cotton, respectively.

In the illustrated embodiment, at block 474 the first node 380b matches an entry in the emissions factors databases. Specifically, the first node 380b matches to a primary entry 382 dyeing of cotton yarn” in the emissions factors database. In some embodiments, the primary entry 382 can be a composite of multiple separate entries in the ecoinvent and/or other emissions factors databases that were previously combined together. For example, in the illustrated embodiment the primary entry 382 is a composite of multiple tiered entries, such as multiple secondary entries 383 (including individual identified secondary entries 383a-b), a tertiary entry 387, and a quaternary entry 388. The secondary entry 383a comprises “cotton” and the secondary entry 383b comprises “dyeing of cotton.” The tertiary entry 387 “cotton fiber” comprises a further decomposition (e.g., a deeper tiered analysis) of the secondary entry 383b “cotton yarn,” and the quaternary entry 388 “seed cotton” comprises a further decomposition of the tertiary entry 387 “cotton fiber.” The lower-level entries 383, 387, and 388 can be aggregated together into the primary entry 382, but can be individually extracted from the ecoinvent or other emissions database.

The primary entry 382 can provide an emissions factor for the first node 380b—for example, a representative (e.g., aggregate) value for the amount of carbon and/or CO₂e equivalent released to the atmosphere when extracting the raw material (e.g., seed cotton), manufacturing the raw material to produce cotton yarn, dyeing the cotton yarn, etc. More specifically, the emissions factor associated with the primary entry 382 can specify the energy inputs (e.g., electricity, fuel, farming/fertilizer, etc.) for the first node 380b and their corresponding carbon emissions—which can be an aggregate of the energy inputs for each of the lower-level entries 383, 387, and 388. Additionally, the emissions factor associated with the primary entry 382 can specify the process emissions for the first node 380b, including emissions from chemical reactions in dyeing cotton, etc.—which can be an aggregate of the process emissions for each of the lower-level entries 383, 387, and 388. Accordingly, after identifying the match to the primary entry 382 in the emissions databases, the method 470 can proceed to block 472 to end processing for the first node 380b.

In the illustrated embodiment, at block 474 the first node 380a does not match an entry in the emissions factors databases such that the method 470 proceeds to block 475 to utilize the AI application to decompose the first node 380a into one or more second nodes 384 of components, materials, and/or manufacturing processes. For example, the first node 380a “buttons” is decomposed into a single second node 384 “plastic.” At block 476, the second node 384 matches an entry in the emissions factors databases. Specifically, the second node 384 matches to a primary entry 385 “plastic” in the emissions factors database. The primary entry 385 can be a composite of multiple separate entries in the ecoinvent and/or other emissions databases as described in detail above. The primary entry 385 can provide an emissions factor for the second node 384—for example, a representative (e.g., aggregate) value for the amount of carbon released to the atmosphere when extracting the raw materials (e.g., cellulose, coal, natural gas, salt, crude oil, etc.) and manufacturing the raw materials to produce plastic. More specifically, the emissions factor associated with the primary entry 385 can specify the energy inputs (e.g., electricity, fuel, etc.) for the second node 384 and their corresponding carbon (and/or CO₂e) emissions and the process emissions (e.g., from chemical reactions, etc.) for the second node 384. Accordingly, after identifying the match to the primary entry 385 in the emissions databases, the method 470 can proceed to block 472 to end processing for the second node 384.

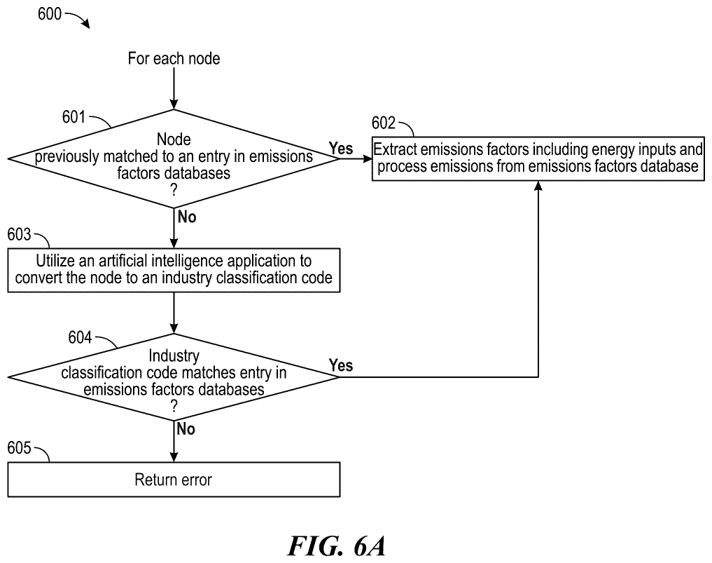

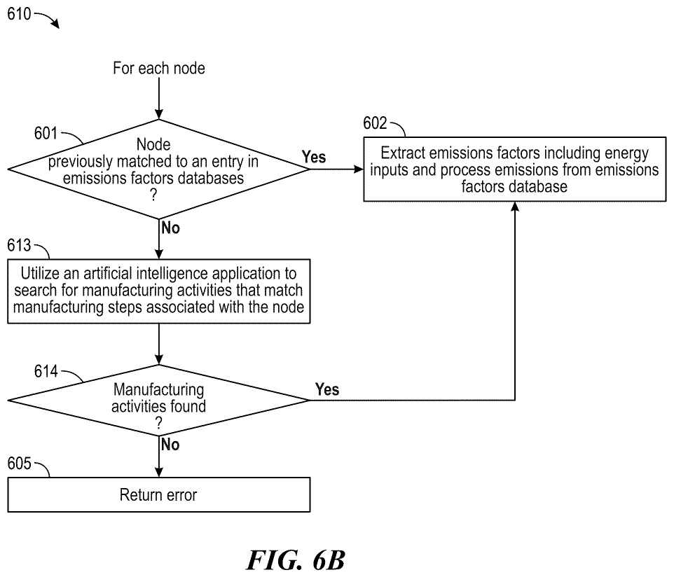

The product decomposition illustrated in FIG. 3B can be modeled as a graph or trace (e.g., an activity trace). The graph comprises a plurality of nodes arranged in tiers, each node representing a material, component, and/or manufacturing process used in the manufacture of the final product (e.g., a “Henley t-shirt”). For example, the specified product (“Henley t-shirt) comprises a primary node 389 at an uppermost tier of the graph. The first nodes 380 are positioned a tier down from the uppermost tier and represent a first level of decomposition of the product. The first nodes 380 are linked to the primary node 389 and separate the graph into different branches. The second node 384 is positioned a tier down from the first nodes 380 and represents a second level of the decomposition of the product, and so on for lower-level nodes. The emissions factors for nodes with direct connections to entries in the emissions factors database (e.g., the first node 380b and the second node 384) can be retrieved/extracted from the matching entries in the emissions factors databases (e.g., the primary entry 382 for the first node 380b and the primary entry 385 for the second node 384). The emissions factors for nodes without direct connections to entries in the emissions factors database (e.g., the primary node 389 and the first node 380a) cannot be retrieved/extracted from the emissions factors database in the same manner. As described in detail below with reference to FIGS. 6A and 6B, such emissions factors can be determined in other manners. In some embodiments, the product decomposition can be continued beyond directly matched nodes to build a deeper graph of the product breakdown.

Referring again to FIG. 2, the manufacturing process generator 266 of the carbon emissions intelligence platform 104 can receive the decomposed product materials, components, and/or manufacturing processes (e.g., some or all of the nodes shown in FIG. 3B) from the BoM validator 254 and/or the product decomposer 257, and determine the manufacturing steps necessary for nodes that do not have a direct connection to an entry in the emissions factors database. For example, the manufacturing process generator 266 can utilize an AI application to identify the sequential manufacturing steps necessary at a node to convert the node's set of input components or materials into the output component or material. As a specific example, a node could have an input of cotton fiber and an output of cotton thread, and the manufacturing process generator 266 could generate a manufacturing step for the node of spinning cotton yarn which would convert the cotton fiber into cotton thread. The manufacturing process generator 266 could generate multiple sequential steps that are necessary to convert the input to the output. In some embodiments, the manufacturing process generator 266 can attach manufacturing steps to nodes to associate them with the transformation processes performed at that node.

Referring again to FIG. 2, the supply chain mapper 256 of the carbon emissions intelligence platform 104 can receive (i) the decomposed product materials, components, and/or manufacturing processes (e.g., some or all of the nodes shown in FIG. 3B) from the manufacturing process generator 266 and (ii) the supplier location 113 (FIG. 1) as one of the product inputs 110, and model/map likely upstream source (e.g., trade) countries for the various materials and components to the supplier location 113. For example, the supply chain mapper 256 can utilize an AI application to identify the most likely countries from which each material and component is sourced by the supplier.

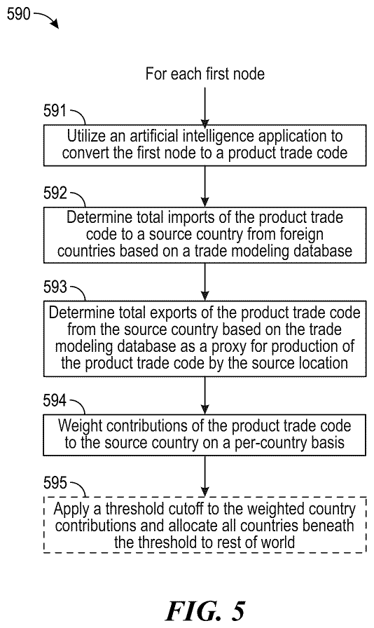

More specifically, FIG. 5 is a block diagram of a process or method 590 that can be carried out by the supply chain mapper 256 to model likely trade countries for the various materials and components of the product in accordance with embodiments of the present technology. The method 590 can model likely source countries for each of the first nodes identified at block 473 of the method 470 (or the likely source countries for the overall product if the method 470 ends after block 471). In other embodiments, the method 590 can model likely source countries for each of the nodes identified by the method 470 (e.g., those at deeper tiers/levels of the product decomposition, such as the second nodes identified at block 475, the third nodes identified at block 477, and so on).

At block 591, the method 590 can include utilizing an artificial intelligence (AI) application (e.g., a generative AI application, a generative AI model, a machine learning (ML) model, a large language model (LLM), and/or the like) to convert the given first node to a product trade code, such as an HTS or HS code. For example, the AI application can be a generative AI application in which a text prompt can be input to find the product trade code associated with the first node. In some embodiments, product trade codes are numerical values having a hierarchical structure in which additional digits more specifically identify a component or material. For example, HS codes are typically organized in a hierarchical structure having a maximum of six digits specified as ABCD.EF, where the first two numbers “AB” designate a general chapter of the hierarchical structure, the next two digits “CD” designate a narrower heading within the chapter, and the final two digits “EF” designate a narrower subheading within the chapter.

In some embodiments, the AI application can match the first node to a product trade code having a maximum number of digits (e.g., six) and corresponding specificity while, in other instances, the AI application may only be able to match the first node to a product trade code having a fewer number of digits (e.g., two, four) and corresponding lesser specificity. For example, referring to FIG. 3B, the HS code for the first node 380a, a button, is 96.06, where the first two digits “96” designate the chapter (e.g., chapter 96: “Miscellaneous Manufactured Articles”) and the final two digits “06” designate the heading within the chapter (e.g., “buttons”). In some embodiments, the AI utilizes information from lower-tier nodes, such as the second node 384, to further specify the product trade code. For example, the HS code for a plastic button is 9606.21, where the first two digits “96” designate the chapter (e.g., chapter 96: “Miscellaneous Manufactured Articles”), the next two digits “06” designate the heading within the chapter (e.g., “buttons”), and the final two digits “21” designate the subheading within the chapter (e.g., “of plastics, not covered with textile material”). Accordingly, the AI application can match the first node 380a to the HS code 9606 or the HS code 9606.21. In some instances, it can be harder to map the second node 380b, dyed cotton, to a full six-digit HS Code based on the provided product inputs 110 and product decomposition. For, example, chapter 52 designates cotton, and headings 1-12 within the chapter designate various types of cotton. The AI application may return HS code “52” to generally designate cotton if it is unable to determine a more specific HS code or, if possible, a more particular HS code such as 5212.13, where the first two digits “52” designate the chapter (e.g., chapter 52: “cottons”), the next two digits “12” designate the heading within the chapter (e.g., “other woven fabrics of cotton”), and the final two digits “13” designate the subheading within the chapter (e.g., “dyed”).

The product inputs 110 (FIGS. 1 and 3A) can optionally include the product trade code 115 (FIGS. 1 and 3A) that specifies one or more product trade codes for the product and/or its components and materials. In such instances, the AI application can utilize the product trade code 115 to narrow, focus, or specify the conversion of the first node to a product trade code.

Referring again to FIG. 5, at block 592, the method 590 can include determining the total imports of the product trade code (e.g., ranging from 2-6 digits) to a source country (e.g., the location of the supplier specified by the supplier location 113 of the product inputs 110 of FIG. 1) from countries foreign to the source country based on one or more trade modeling databases (e.g., the trade modeling databases 142). For example, the AI application can query the United Nations ComTrade database and/or the CEPII BACI database to determine the total imports of the product trade code to the source country on a per-country basis. For individual countries not in the database, the database may designate imports from the rest of the world (RoW) as an aggregate for many smaller countries.

In some embodiments, the product inputs 110 (FIGS. 1 and 3A) can optionally include the upstream suppliers 118 (FIGS. 1 and 3A) that specify one or more known upstream suppliers. In such instances, at block 592, the method 590 can only determine total imports of the product trade code from the countries of the specified upstream suppliers 118.

At block 593, the method 590 can include determining the total exports of the product trade code from the source country based on the one or more trade modeling databases. For example, the AI application can query the United Nations ComTrade database and/or the CEPII BACI database to determine the total exports of the product trade code from the source country to the ROW. The total exports of the product trade code from the source country can be used in the method 590 as a proxy for domestic production of the product trade code by the source country. If data for domestic production of materials, goods, etc., exists, the method 590 can match such data to the identified product trade code. In other embodiments, domestic production of the product can be estimated in other ways, such as using explicit country reported production data.

At block 594, the method 590 can include weighting the contributions of the product trade code to the source country on a per-country basis. The weights for foreign importer countries (block 592) can be determined as percentiles according to the equation below by dividing the total number of imports of the product trade code from the importer country by the sum of the total imports of the product trade code to the source country and the total exports of the product trade code from the source country (e.g., as a proxy for domestic production).

$$\frac{( total imports from importer country )}{( total imports to source country ) + ( total exports from source country )}$$

The weight for the source country's domestic production can be determined as a percentile according to the equation below by dividing the total number of exports of the product trade code from the source country by the sum of the total imports of the product trade code to the source country and the total exports of the product trade code from the source country.

$$\frac{( total exports from source country )}{( total imports to source country ) + ( total exports from source country )}$$

At block 595, the method 590 can optionally include applying a threshold cutoff to the weighted country contributions and allocating all countries beneath the threshold to trade with the rest of the world (RoW). For example, all countries contributing less than 1%, less than 2.5%, less than 5%, less than 10%, etc., of the product trade code to the source country can be excluded from the weighted contributions and the threshold percentage can be allocated to trade with the RoW.

FIG. 3C is a schematic view of a supply chain mapping of the example Henley T-shirt product in accordance with the method 590 of FIG. 5. Referring to FIGS. 3C and 5, at block 591 the AI application can covert the first node 380a “buttons” to a product trade code, such as HS code 9606.21 described in detail above. At blocks 592-595, the method 590 can determine weighted contributions 396 (including individually identified first through third weighted contributions 396a-c) of the product trade code 9606.21 to the source country Vietnam. In the illustrated embodiment, for example, the method 590 can determine that 20% of buttons are produced domestically by Vietnam (e.g., the first weighted contribution 396a; blocks 593 and 594), 50% of buttons are imported from China (e.g., the second weighted contribution 396b; blocks 592 and 594), and 30% of buttons are imported from smaller countries below the threshold cutoff and therefore allocated to the RoW (e.g., the third weighted contribution 396c; blocks 592, 594, and 595). Similarly, at block 591 the AI application can covert the first node 380b “dyed cotton” to a product trade code, such as HS code 52 described in detail above. At blocks 592-595, the method 590 can determine weighted contributions 397 (including individually identified first through fourth weighted contributions 397a-d) of the product trade code 52 to the source country Vietnam. In the illustrated embodiment, for example, the method 590 can determine that 60% of dyed cotton is produced domestically by Vietnam (e.g., the first weighted contribution 397a; blocks 593 and 594), 5% of dyed cotton is imported from India (e.g., the second weighted contribution 397b; blocks 592 and 594), 30% of dyed cotton is imported from China (e.g., the third weighted contribution 397c; blocks 592 and 594), and 5% of dyed cotton is imported from smaller countries below the threshold cutoff and therefore allocated to the ROW (e.g., the fourth weighted contribution 397d; blocks 592, 594, and 595).

While the embodiments of FIGS. 3C and 5 show supply chain mapping of the first nodes 380, the method 590 can similarly include mapping the supply chain contributions to lower-tier nodes, such as the second node 384 shown in FIG. 3B. That is, the method 590 can similarly utilize the AI application to convert/map the second node 384 and/or lower-tier nodes (e.g., e.g., third nodes, fourth nodes, or lower nodes) to product trade codes and determine weighted contributions of the product trade code to the source country (e.g., the country of the supplier supplying the second or lower node) on a per-country basis. The tradeoff for analysis of deeper nodes is computational expense, as the graph grows exponentially with each lower-tier node included in the computation.

Referring again to FIG. 2, a product emissions estimator 258 of the carbon emissions intelligence platform 104 can estimate emissions for each product component, material, and/or manufacturing process (e.g., node). For example, at block 259, the product emissions estimator 258 can identify a closest match (e.g., entry) for each node in the emissions factors databases, such as the material/component emissions factors database 140 and/or the manufacturing emissions factors database 141 of FIG. 1. Additionally or alternatively, the product emissions estimator 258 can determine whether the emissions for a given node were specified in the product inputs 110 (e.g., in the supplier emission data 190 of FIG. 1), in which case further estimation is not needed. If a match is not identified (“no”), at block 260, the error generator 252 can generate an error message, such as for display at the user application 102 (FIG. 1). If a match is identified (“yes”), the product emissions estimator 258 can extract energy inputs (e.g., fuel and electricity usage) and process emissions (e.g., from chemical reactions, etc.) from the emissions factors databases for each node at block 261.

FIG. 6A is a flow diagram of a method or process 600 for identifying a closest match (e.g., entry) for each node in the emissions factors databases and extracting fuel and electricity usage for each node in accordance with embodiments of the present technology. That is, for example, the method 600 provides a more detailed analysis of blocks 259-261 of FIG. 2. At block 601, the method 600 can include identifying whether the node previously matched to an entry in the emissions factors databases. If yes, the method 600 can proceed to block 602 to retrieve the emissions factors associated with the node including the energy inputs (e.g., electricity, fuel, etc.) and process emissions (e.g., from chemical reaction, etc.) associated therewith. For example, the node can previously be matched to an entry in the emissions factors databases via the method 470 described in detail with reference to FIG. 4. More specifically, for example, referring to FIG. 3B, the first node 380b “dyed cotton” matches to the primary entry 382 “dyeing of cotton yarn” in the emissions factors databases, and the second node 384 matches to the primary entry 385 “plastic” in the emissions factors databases. However, the primary node 389 “Henley t-shirt” and the first node 380a “buttons” do not match an entry in the emissions factors databases. That is, for example, a given manufacturing or processing node may not match to an entry in the emissions factors databases (e.g., the ecoinvent database).

Accordingly, referring to FIG. 6A, if the node is not matched to an entry in the emissions factors database, the method 600 can proceed to block 603 to utilize an artificial intelligence (AI) application (e.g., a generative AI application, a generative AI model, a machine learning (ML) model, a large language model (LLM), and/or the like) to convert the node to an industry classification code, such as a North American Industry Classification System (NAICS) code. For example, the AI application can be a generative AI application in which a text prompt can be input to find the industry classification code associated with the node. In some embodiments, industry classification codes are numerical values having a hierarchical structure in which additional digits more specifically identify an industry. For example, NAICS codes are typically organized in a hierarchical structure having a maximum of six digits specified as ABCDEF, where the first two numbers “AB” designate an industry sector, the third number “C” designates a subsector within the sector, the fourth digit “D” designates an industry group within the sector, the fifth digit “E” designates an industry within the industry group, and the sixth digit “F” designates a national industry within the industry.

In some embodiments, the AI application can match the node to an industry classification code having a maximum number of digits (e.g., six) and corresponding specificity while, in other instances, the AI application may only be able to match the node to an industry classification code having a fewer number of digits (e.g., two, three, four, five) and corresponding lesser specificity. For example, referring to FIG. 3B, the AI application can match the first node 380a “buttons” to NAICS code 3261, where the first two digits “32” designate the manufacturing sector, the third digit “6” designates the “plastics and rubber products manufacturing” subsector, and the fourth digit “1” designates the “plastics product manufacturing” industry group. In some instances, the AI application can further match the node to a more specific NAICS code, such as 326199, where the additional trailing digits “9” and “9” designate the “other plastics product manufacturing” industry group and the “all other plastics product manufacturing” national industry, respectively.

Referring again to FIG. 6A, at block 604 the AI application can determine whether the industry classification code for the node matches an entry in the emissions factors databases, such as the manufacturing emissions factors databases 141 of FIG. 1. In some embodiments, the AI application finds the best match for the industry classification code by first starting with a 6-digit code (if determined), then moving to more general 5-digit, 4-digit, 3-digit, and 2-digit codes if the more specific code does not match an entry in the manufacturing emissions factors databases 141. If a match for the node is found in the manufacturing emissions factors databases 141 (e.g., “yes”), the method 600 can proceed to block 602 to retrieve the emissions factors associated with the node including the energy inputs (e.g., electricity, fuel, etc.) and the process emissions (e.g., from chemical reactions, etc.) associated therewith. In some embodiments, a given industry classification code may match multiple entries in the manufacturing emissions factors database. In such instances, the method 600 can return the average, median, or other weighted blend of the emissions factors matching the industry classification code. In some embodiments, the method 600 can randomly sample the multiple entries using, for example, a Monte Carlo analysis, to determine an uncertainty associated with the calculated emissions factors. If no, the method 600 can proceed to block 605 to return an error message.

FIG. 6B is a flow diagram of a method or process 610 for identifying a closest match (e.g., entry) for each node in the emissions factors databases and extracting fuel and electricity usage for each node in accordance with additional embodiments of the present technology. The method 610 can include some features generally similar or identical to the method 600 described in detail with reference to FIG. 6A. For example, in the illustrated embodiment the method 610 includes the same blocks 601, 602, and 605.

However, if the node is not matched to an entry in the emissions factors database at block 601, the method 600 can proceed to block 613 to utilize an artificial intelligence (AI) application (e.g., a generative AI application, a generative AI model, a machine learning (ML) model, a large language model (LLM), retrieval-augmented generation (RAG) model, and/or the like) to find the most relevant activities in the emissions factor databases or manufacturing emissions databases that match to the manufacturing steps generated by the manufacturing process generator 266. For example, the AI application can be a RAG application in which the manufacturing step information can be input to find the closest matching manufacturing emission factor activity in the manufacturing emissions factor databases.

In some embodiments, the AI application can return multiple closely matching activities from the manufacturing emissions factor databases and take a statistical approach to average the emission factors. For example, a weighted average based on likelihood of match can be used to weight the final emission factor based on the likelihood of the activities being a good match to the manufacturing step. Such a likelihood can be provided as part of the AI application output.

At block 614 the AI application can determine whether sufficient quality manufacturing activities were found for the manufacturing steps of the node. If a sufficient quality matches for the node were found in the manufacturing emissions factors databases 141 (FIG. 1; e.g., “yes”), the method 600 can proceed to block 602 to retrieve the emissions factors associated with the node including the energy inputs (e.g., electricity, fuel, etc.) and the process emissions (e.g., from chemical reactions, etc.) associated therewith. In some embodiments, a given manufacturing step or activity may match multiple entries in the manufacturing emissions factors database. In such instances, the method 600 can return the average, median, or other weighted blend of the emissions factors matching the industry classification code. In some embodiments, the method 600 can randomly sample the multiple entries using, for example, a Monte Carlo analysis, to determine an uncertainty associated with the calculated emissions factors. If no, the method 600 can proceed to block 605 to return an error message.

Referring again to FIG. 2, after extracting energy inputs for each of the decomposed product components, materials, and/or manufacturing processes (e.g., nodes), at block 262 the product emissions estimator 258 can adjust the extracted energy inputs for each node. Referring to FIGS. 2, and 3B, to adjust the extracted energy inputs of the primary node 389, the product emissions estimator 258 can access the energy grid makeup databases 143 (FIG. 1) to determine the grid makeup of the supplier country Vietnam and adjust the emissions for the primary node 389 from the energy inputs based on the grid makeup Vietnam. If the supplier location (FIG. 1) is more specific than a country, and the grid data in grid makeup databases 143 includes more granular grid information, the emissions of the primary node 389 can be adjusted based on the more granular grid data (e.g., adjusting for the grid makeup of Ho Chi Minh city for a supplier located in Ho Chi Minh rather than for the grid makeup of Vietnam as a whole). Alternatively or additionally, rather than matching the primary node 389 to an industry trade code to determine emissions via the method 600 of FIG. 6A (and/or FIG. 6B) and adjusting the extracted energy inputs associated therewith, if the emissions for the primary node 389 are specified in the product inputs 110 (e.g., the supplier emissions data 190 of FIG. 1), the products emissions estimator 258 can simply return the reported supplier emissions data 190 for the primary node 389.

For lower-tier nodes, such as the first nodes 380 and the second node 384, the product emissions estimator 258 can weight the energy inputs based on the supply chain map generated by the supply chain mapper 256 to adjust the emissions factors for each node. For example, the product emissions estimator 258 can access the energy grid makeup databases 143 (FIG. 1) to determine the grid makeup of the countries identified by the supply chain mapper 256 and adjust the emissions from the energy inputs based on the grid makeup of the particular countries. More specifically, for example, referring to FIGS. 2, 3B, and 3C, the supply chain mapper 256 can determine that 20% of the first node 380a “buttons” is produced domestically by Vietnam (e.g., the first weighted contribution 396a), 50% of the first node 380a is imported from China (e.g., the second weighted contribution 396b), and 30% of the first node 380a is imported from the ROW (e.g., the third weighted contribution 396c). Accordingly, the product emissions estimator 258 can retrieve energy grid information from the energy grid makeup databases 143 about the energy grid makeup of Vietnam, China, and the ROW, such as the percentage of electricity generated via green (e.g., carbon free technologies), the percentage of electricity generated via burning specific fossil fuels, etc., and adjust the emissions associated with the first node 380a in the emissions factors database accordingly. That is, the product emissions estimator 258 can adjust the energy (e.g., electricity) inputs from the emissions factor database associated with the primary entry 385 “plastic” for the second node 384 as well as the energy inputs for the first node 380a (e.g., as extracted according to the method 600 of FIGS. 6A and/or 6B). The result is an adjustment of the emissions factors (e.g., carbon emissions, carbon dioxide equivalence (CO₂e) emissions) for each component, material, and/or process (e.g., node) of the product depending on the location of the supplier (e.g., source location) and the probabilistic view of where the supplier sources the components and materials for the product.

Referring to FIG. 2, the production emissions estimator 258 can specify the overall carbon emissions to produce the product without accounting for transport of the product. Accordingly, a transport emissions estimator 263 of the carbon emissions intelligence platform 104 can calculate emissions factors for the various transportation steps of (i) transporting the final product to the destination location and (ii) transporting the various components and materials of the product to the supplier location. For example, FIG. 3D is a schematic view of a transport mapping of the example Henley T-shirt product. In the illustrated embodiment, the product (e.g., t-shirt) must be transported across a first transport route 307 (e.g., transport link, transport step) between the supplier location 113 (e.g., Vietnam) and the destination location 114 (e.g., Seattle, WA). Likewise, the first node 380a “buttons” may be transported across multiple possible transportation links 308a-c from the upstream supplier locations 396a-c (e.g., Vietnam, China, RoW), respectively, to the supplier location 113 (e.g., Vietnam), and the second node 380b “dyed cotton” may be transported across multiple possible transportation links 309a-d from the upstream supplier locations 397a-d (e.g., Vietnam, India, China, RoW), respectively, to the supplier location 113.

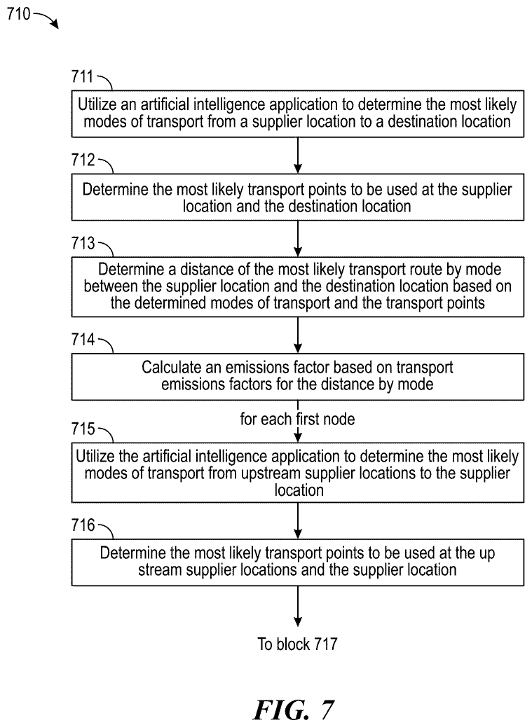

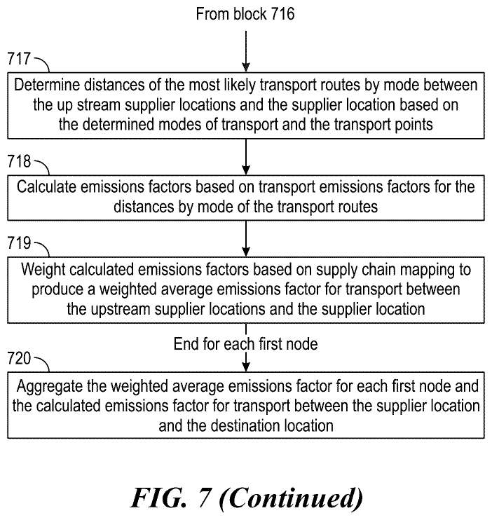

FIG. 7 is a block diagram of a process or method 710 that can be carried out by the transport emissions estimator 263 to estimate emissions factors for the various transportation steps in accordance with embodiments of the present technology. Some aspects of the method 710 are described with reference to FIG. 3D. At block 711, the method 710 can include utilizing an artificial intelligence (AI) application (e.g., a generative AI application, a generative AI model, a machine learning (ML) model, a large language model (LLM), and/or the like) to determine the most likely modes (e.g., sequence of one or more modes) of transport from a supplier location to a destination location for the given product. The modes of transport can be rail, sea, air, road, and/or the like. For example, the AI application can be a generative AI application in which a text prompt can be input to find the most likely transport modes between the supplier location and the destination location. With reference to FIG. 3D, for example, the AI application can determine that the most likely mode of transport from the supplier location 113 in Vietnam to the destination location 114 in Seattle, Washington, USA, is via truck, then ship, and finally truck.

At block 712 the method 710 can include determining the most likely transport points to be used near the supplier location and the destination location. The transport points may be ports, seaports, airports, freight stations, truck stations, rail stations, and/or the like. In some embodiments, the AI application can determine the most likely transport points by querying one or more transport databases, such as the transport databases 144 of FIG. 1, to determine major transport points geographically near the supplier and destination locations. With reference to FIG. 3D, for example, the AI application can determine that the most likely transport point for a sea route from the supplier location 113 Vietnam is a seaport located in Ho Chi Minh City and that the most likely receiving transport point is a seaport at the destination location Seattle, Washington is located in Seattle.

At block 713, the method 710 can include determining a distance of the most likely transport route by mode between the supplier location and the destination location based on the determined modes of transport and the transport points. For example, the AI application can determine the distance of the most likely transport route using the Sea Route python package for sea routes, great circle distances for air routes, and/or the like. The method 710 can determine a distance of each mode of a sequence of modes along the route. For example, with reference to FIG. 3D, the AI application can determine a distance of the initial truck route from near the supplier location 113 in Vietnam to a seaport near the supplier location 113, a distance of the sea route from the seaport near the supplier location 113 to a seaport near the destination location 114 in Seattle, Washington, USA, and finally a distance of the truck route from the seaport near the destination location 114 to the destination location 114.

At block 714, the method 710 can include calculating an emissions factor (e.g., carbon emissions) for the modes of transport and the distances of the transport route. For example, the AI application can query the transport databases, such as the transport databases 144 of FIG. 1, to determine emissions factors for the mode of transport and apply the emissions factors to the determined distances to calculate an emissions factor for the likely transport route—for example, the transport route 307 between the supplier location 113 in Vietnam and the destination location 114 in Seattle, Washington shown in FIG. 3D.

Blocks 715-718 can be carried out to calculate emissions for the likely transport of each identified first node to the supplier location. For example, blocks 715-718 can be generally similar or identical to blocks 711-714 but operate to calculate emissions factors for each potential transport route between a location of an upstream supplier identified by the supply chain mapper 256 (FIG. 2) and the supplier location.

At block 715, the method 710 can include utilizing the AI application to determine the most likely modes of transport from identified upstream supplier locations to the supplier location. At block 716, the method 710 can include determining the most likely transport points to be used near the upstream supplier locations and the supplier location. At block 717, the method 710 can include determining distances of the most likely transport routes by mode between the upstream supplier locations and the supplier location based on the determined modes of transport and the transport points. At block 718, the method 710 can include calculating emissions factors (e.g., carbon emissions) for the modes of transport and the distances of the transport routes. That is, referring to FIG. 3D, the method 710 can determine emissions factors for each of (i) the transport routes 308a-c between the first node 380a and the supplier location 113 and (ii) the transport routes 309a-d between the second node 380b and the supplier location 113.

At block 719, the method 710 can include weighting the calculated emissions factors for each first node based on the supply chain mapping carried out by the supply chain mapper 256 (FIG. 2). For example, referring to FIG. 3D, the method 710 can weight the emissions factors calculated at block 718 for the individual transport routes 308a-c based on their respective expected contributions of 20%, 50%, and 30%, respectively. That is, the emissions factor for the transport route 308b for transporting buttons produced in China to Vietnam can be weighted more heavily than (i) the transport route 308a for transporting buttons produced domestically in Vietnam and (ii) the transport route 308b for transporting buttons produce in the RoW to Vietnam.

Finally, at block 720, the method 710 can include aggregating the weighted average emissions factor for each first node (block 719) and the calculated emissions factor for transport between the supplier location and the destination location (block 714). Referring to FIG. 3D, the end result is an aggregate emissions factor for transport along each of the transport routes 307, 308a-c, and 309a-d that takes into account the probabilistic nature of where the component parts and materials (e.g., the first nodes 380) of the product will be sourced upstream from.

While the embodiments of FIGS. 3D and 7 show the calculation of emissions factors for transport of only the first nodes 380 to the supplier location, the method 710 can include calculating emissions factors for transport of lower-tier nodes, such as the second node 384 shown in FIG. 3B. That is, the method 710 can similarly utilize the AI application to determine emissions factors for likely trade routes between the first node 380a and the second node 384 and/or between lower-tier nodes (e.g., e.g., third nodes, fourth nodes, or lower nodes). The tradeoff for analysis of deeper nodes is computational expense, as the graph grows exponentially with each lower-tier node included in the computation.

Referring again to FIG. 2, an uncertainty estimator 264 of the carbon emissions intelligence platform 104 can calculate an uncertainty for the emissions factors estimate for each node and the various transport steps. For example, where the emissions factors for a node are calculated by adjusting emissions factors in the material/component emissions factors databases 140 of FIG. 1 (e.g., for the first node 380b and the second node 384 shown in FIG. 3B), the uncertainty estimator 264 can extract a related uncertainty distribution from the emissions factors databases 140. Similarly, where the emissions factors for a node are calculated by retrieving a value associated with an industry classification code and/or a manufacturing activity in the manufacturing emissions databases 141 of FIG. 1 (e.g., the primary node 389 and the first node 380a), the uncertainty estimator 264 can sample multiple closely matched emissions factors entries associated with the industry classification code and/or manufacturing activity to generate an uncertainty distribution. Likewise, the uncertainty estimator 264 can generate an uncertainty distribution for each transport step/link (e.g., from a pedigree matrix). The uncertainty estimator 264 can then sample the uncertainty distributions (e.g., via a Monte Carlo analysis) for each node and transport step/link and the associated data entries of emissions factors to generate an uncertainty or variance of each node and transport link. Additionally, emission factors in the emission factor databases and/or manufacturing databases could have uncertainty values associated with the factor. The database entry uncertainty values can also be used as input to the uncertainty estimator 264. The uncertainty or variance can be presented as a confidence interval or rating.

An output aggregator 265 of the carbon emissions intelligence platform 104 can aggregate the emissions factors for each of the product components, materials, and/or manufacturing processes (e.g., nodes) from the product emissions estimator 258 and the emissions factors for transporting the various components, materials, and final product from the transport emissions estimator 263. The output aggregator 265 can output the emissions outputs 120 for display at, for example, the user application 102 (FIG. 1). The output aggregator 265 can further aggregate the uncertainties generated by the uncertainty estimator 264 to generate an aggregate uncertainty (and/or confidence interval) associated with the emissions outputs 120. In some embodiments, the uncertainty values can be aggregated by a statistical metric based on other values of the nodes. For example, a weighted average of uncertainty can be aggregated with weight being based on the emissions of the node.

In some aspects of the present technology, the end result of the modeling carried out by carbon emissions intelligence platform 104 is a probabilistic graph model that consists of nodes representing manufacturing, processing, production, and/or material extraction steps and links that represent the transport between different steps. Each node has associated data about the component/material being produced at that step and the mass, the emissions factor of the step, the total emissions based on the mass, the energy inputs, the manufacturing steps, and the relative weight of the node. Each link has associated data about the source location, destination location, component/material and mass being transported, the modes of transport and their respective distances and emissions, the emissions factor of the link, the total emissions based on the mass, and the relative weight of the link. This information can be presented within the emissions outputs 120 at the user application 102 (FIG. 1) in various forms, as described in greater detail below with reference to FIGS. 8A-10.

In some embodiments, the carbon emissions intelligence platform 104 can process the product inputs 110 to model global average emissions for the product that is not specific to a particular supplier location. For example, the product emissions estimator 258 can, at block 262, extract emissions factors for each node representative of the global average emissions (or other high-level region, such as RoW). That is, the product emissions estimator 258 need not adjust the energy inputs based on a supply chain map at block 262—instead more simply extracting the global average emissions. The transport emissions estimator 263 can similarly calculate a global average by finding most likely modes and sourcing countries for each transport step in the product breakdown. For example, the transport emissions estimator 263 can map the product to a product trade code (e.g., an HS code) and utilize the trade modeling database 142 (FIG. 1) to find the largest (e.g., three largest, five largest, etc.) importers of the product trade code to the destination location, similar to the method 590 of FIG. 5. The transport emissions estimator 263 can then determine the likely modes of transportation and routes from the largest importers, calculate emissions factors for the routes, and weight the emissions factors to determine a globally-averaged transport emissions value. The output aggregator 265 can aggregate the globally-averaged emissions factors for the various product components, materials, and processes, and the globally-averaged emissions factors for the various transport steps to generate globally-averaged emissions factors for the product. The globally-averaged emissions factors can be, for example, used as a source of comparison to the modeled emissions factors for the selected supplier location.

Referring to FIGS. 1-7, different aspects/components of the present technology can utilize an AI application (e.g., to decompose a product, find likely sourcing components for a node, etc.). The AI application can be the same or different. For example, as used herein, for ease of reference, a first component or step of the present technology can utilize/execute a first AI application, a second component or step of the present technology can utilize/execute a second AI application, a third component or step of the present technology can utilize/execute a third AI application, and so on. The first, second, third, and/or additional AI applications can be the same or different.

### II. SELECTED EMBODIMENTS OF USER INTERFACES TO DISPLAY CARBON EMISSIONS OUTPUTS

Referring to FIGS. 1 and 2, the user application 102 can include a user interface for receiving the product inputs 110, and the carbon emissions intelligence platform 104 can model the emissions for a product based on the product inputs 110 input into the user interface. The user interface of the user application 102 can further display the carbon emissions outputs 120 as a report including a detailed breakdown of the sources, contributing factors, etc., of the carbon emissions for the product.

For example, FIGS. 8A-8D are screenshots of different portions, pages, and/or displays of a user interface 840 of the user application 102 of the platform 100 of FIG. 1 in accordance with embodiments of the present technology. FIG. 8A illustrates an input field 841 of the user interface 840 having a user input regions 842 (including individually identified first through fifth user input regions 842a-f) for receiving some or all of the product inputs 110 (FIG. 1). The user input regions 842 can be text input boxes, drop-down menus, and/or the like, for receiving a user input specifying a product, and can be searchable. In other embodiments, the product inputs 110 can be populated in a spreadsheet or other computer-readable form and uploaded directly to the user application 102. In the illustrated embodiment, the first user input region 842a is configured to receive the product description 111 (a “Henley t-shirt”), the second user input region 842b is configured to receive the source location 113 (e.g., the location of the supplier; “Vietnam”), the third user input region 842c is configured to receive the destination location 114 (“Seattle, WA, USA”), and the fourth user input region 842d is configured to the receive the declared mass 112 (“100 kg”). In the illustrated embodiment, the fifth user input region 842e can be a selectable drop-down menu for receiving a mass unit 843 (e.g., kilograms, pounds, tons, etc.). The user interface 840 can further include a togglable menu 844 for displaying additional input regions for entering additional (e.g., optional) ones of the product inputs 110.

FIG. 8B illustrates the display of an emissions report on the user interface 840 for the inputs entered into the input field shown in FIG. 8A (and as described in detail above with reference to FIGS. 2-7). In the illustrated embodiment, the emissions report includes a total emissions value 845 for the cradle-to-gate life cycle (e.g., from extraction of raw materials, through manufacturing, and through shipping to the product destination in Seattle, WA) of the Henley t-shirt, an emissions factor value 846 for the cradle-to-gate life cycle of the Henley t-shirt, and a comparison to global value 847 for the cradle-to-gate life cycle of the Henley t-shirt. The total emissions value 845 is the calculated total carbon emissions (e.g., kilograms of carbon dioxide) emitted, the emissions factor value 846 is the calculated total carbon emissions per unit of the declared mass (e.g., per kilogram), and the comparison to global value 847 is a percentage comparing the emissions factor value 846 (and/or the total emissions value 845) to a globally-averaged emissions factor value modeled for the Henley t-shirt, as described in detail above.

The emissions report can further include various graphs, charts, mappings, and/or graphics breaking down the emissions, such as a sourcing country emission breakdown 848, a raw material emission breakdown 849, a tier emission breakdown 850, a contribution analysis 851, and a transport analysis 852 (collectively “emissions indicators 848-852”). The sourcing country emission breakdown 848 can be a pie chart or other graphic illustrating the emissions contributions (e.g., percentages) of each upstream supplier supplying materials and/or components of the Henley t-shirt to the supplier in Vietnam. For example, in the illustrated embodiment the sourcing country emission breakdown 848 indicates that 81.75% of predicted emissions from upstream suppliers come from China, 8.80% of predicted emissions from upstream suppliers come from Vietnam, and 9.45% of predicted emissions from upstream suppliers come from the RoW. The raw material emission breakdown 849 can be a pie chart or other graphic illustrating the emissions contributions (e.g., percentages) of each raw material used in the product. For example, in the illustrated embodiment the raw material emission breakdown 849 indicates that cotton fabric accounts for 95.93% of the predicted emissions while buttons, plastic and or other factors account for much smaller fractions.

The tier emission breakdown 850 can be a pie chart or other graphic illustrating the emissions contributions (e.g., percentages) of tiers of processing steps for producing the product. For example, in the illustrated embodiment the tier emission breakdown 850 indicates that tier-4 and beyond processes accounts for 49.76% of the predicted emissions, tier-3 processes account for 23.76% of emissions, tier-2 processes account for 20.41% of emissions, and tier-1 process account for the rest of the emissions (e.g., 6.07%). Referring to FIG. 3B, tier-1 processes may include manufacturing the primary node 389 “Henley t-shirt” from buttons and dyed cotton, tier-2 may include manufacturing the first node 380a “buttons” and the first node 380b “dyed cotton,” tier-3 processes may include producing plastic, cotton yarn, and dyeing cotton yarn, and tier-4 processes may include generating cotton fiber, generating seed cotton, etc., and other processes nearer to the cradle.

The contribution analysis 851 can be a Sankey diagram or other graphic illustrating the relative emissions contributions of various aspects of the cradle-to-gate life cycle of the Henley t-shirt. For example, from left to right as shown, the contribution analysis 851 can include (i) a first graph portion 853a illustrating the total emissions for the Henley t-shirt, (ii) a second graph portion 853b breaking down the total emissions into the relative weights of the upstream emissions, the manufacturing emissions (e.g., emissions from the supplier manufacturing the Henley t-shirt), and the transport emissions, (iii) a third graph portion 853b breaking the upstream emissions into the relative weights of the emissions from components and/or materials making up the Henley t-shirt (e.g., cotton fabric, polyester thread, plastic buttons), and (iv) a fourth graph portion 854d breaking the manufacturing emissions and the emissions from components and/or materials making up the Henley t-shirt into emissions per country.

The transport analysis 852 can comprise a map or other graphic illustrating the transport path(s) of the final Henley t-shirt and or its component and/or materials. For example, in the illustrated embodiment the transport analysis 852 shows a most likely transport route 854 (e.g., a sea route) for the Henley T-shirt from Vietnam to Seattle, Washington, and a most likely transport route 855 for a component (e.g., plastic buttons) from an upstream supplier in China to the supplier located in Vietnam.

Some or all of the emissions indicators 848-852 can be interactive. That is a user can interact with the user interface 840 via a user input (e.g., click of a mouse, positioning of a cursor, and/or the like) to reveal different and/or additional information. For example, in some embodiments positioning a cursor over (e.g., hovering over) and/or clicking on any of the individual slices of the sourcing country emission breakdown 848, the raw material emission breakdown 849, and/or the tier emission breakdown 850 reveals the total emissions and/or emissions factor for that slice (e.g., in a text pop-up). Likewise, in some embodiments positioning the cursor over and/or clicking on any of the flow paths of the contribution analysis 851 reveals the total emissions and/or emissions factor for that portion of the cradle-to-gate life cycle of the Henley t-shirt. Similarly, positioning the cursor over and/or clicking on the transport routes 854 and 855 can reveal the total emissions and/or emissions factor for that portion of the transport of the Henley t-shirt.

In some aspects of the present technology, the user interface 840 can aid a user, such as a customer making decisions about their supply chain, in understanding the carbon emissions associated therewith and, more particularly, in understanding manners in which they may be able to reduce carbon emissions. For example, in the illustrated embodiment the comparison to global value 847 can indicate that the Henley t-shirt manufactured in Vietnam is likely to have relatively high emissions compared to global and therefore that there may be changes that could reduce emissions by, for example, selecting a different supplier. The sourcing country emission breakdown 848 can indicate that the bulk of upstream emissions are likely to come from China such that a change in upstream supplier (e.g., to one with cleaner energy grid) could reduce emissions. The sourcing country emission breakdown 849 can indicate that the bulk of material emissions come from the procurement and processing of cotton fabric such that a change in material could reduce emissions. The tier emission breakdown 850 can indicate that the bulk of emissions come from upstream processes not carried out by the selected supplier in Vietnam (e.g., tier 1) such that the user may not have much control in reducing emissions other than selecting another supplier.

FIG. 8C illustrates the display of an emissions report on the user interface 840 including a bucketed list 856 and a globally benchmarked list 857 of the top contributing factors to total emissions. The bucketed list 856 can list/rank the top contributing factors for the specific product inputs (e.g., as shown in FIG. 8A)—such as upstream emissions for the Henley t-shirt (contributing 1010.21 kilograms of carbon emissions), upstream emissions for producing cotton fabric (contributing 969.35 kilograms of carbon emissions), etc. The bucketed list 856 can essentially provide a list version of the information displayed in the contribution analysis 851 (FIG. 8B). The globally benchmarked list 857 can list/rank the top contributing factors that have the greatest impact on the comparison to global value 847 (FIG. 8B). That is, the globally benchmarked list 857 can rank the factors having the greatest relative impact on the comparison to global value 847. In some aspects of the present technology, the globally benchmarked list 857 can aid the user in understanding which factors in the supply chain may be most beneficial and/or easiest to change to reduce carbon emissions.

FIG. 8D illustrates the display of an emissions report on the user interface 840 including a table including a list 863 the top contributing factors to total emissions along with a corresponding category list 864 identifying a category (e.g., material, manufacturing, transport, etc.) of the top contributing factors, a comparison to global contribution list 866 identifying a percentage contribution to the overall product comparison to global emissions score (e.g., with positive, non-zero percentages indicating higher contribution) of the top contributing factors, an emission contribution list 867 identifying a percentage contribution to the overall product emissions of the top contributing factors, a contribution list 865 identifying a weighted average of the comparison to global contribution score and emission contribution score, and/or the like.

Referring to FIGS. 1 and 2, the user application 102 can include a user interface for receiving product inputs for multiple different products (e.g., a batch of products), and the carbon emissions intelligence platform 104 can model the emissions from the individual products based on the product inputs. The user interface of the user application 102 can further display carbon emissions outputs for the products individually or collectively as a report (e.g., a composite report, an aggregate report) including a detailed breakdown of the sources, contributing factors, etc., of the carbon emissions.

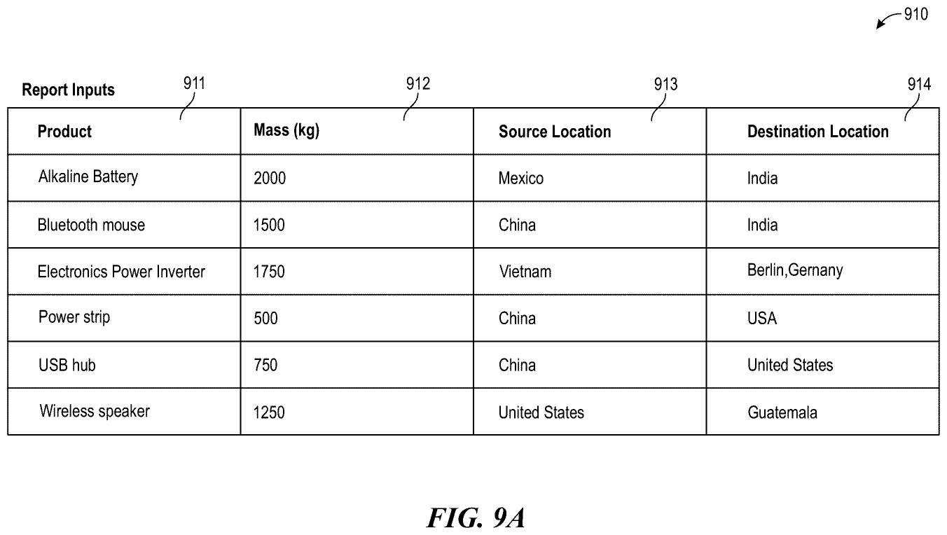

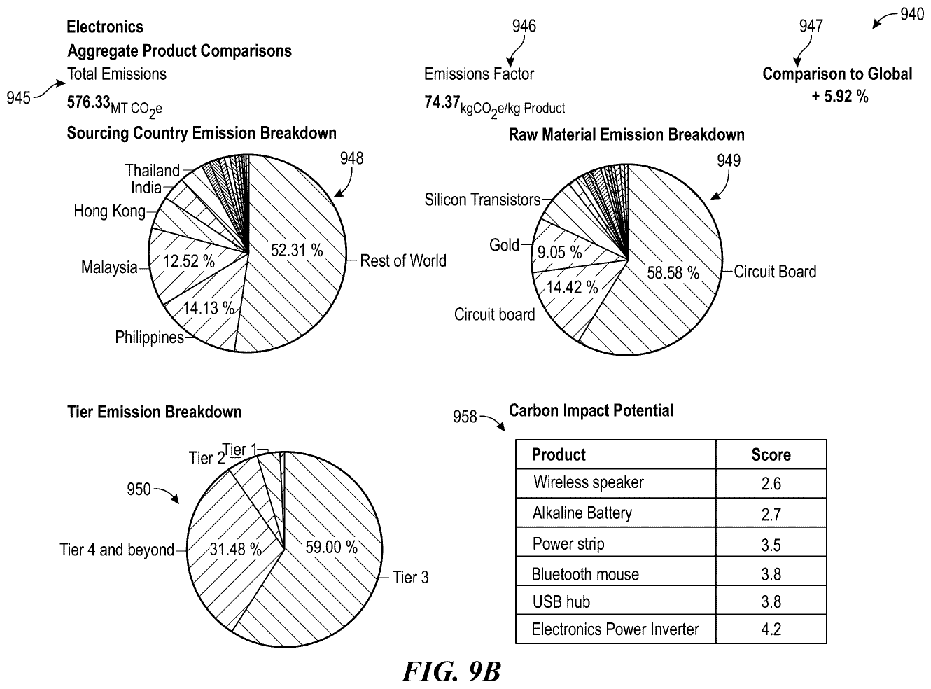

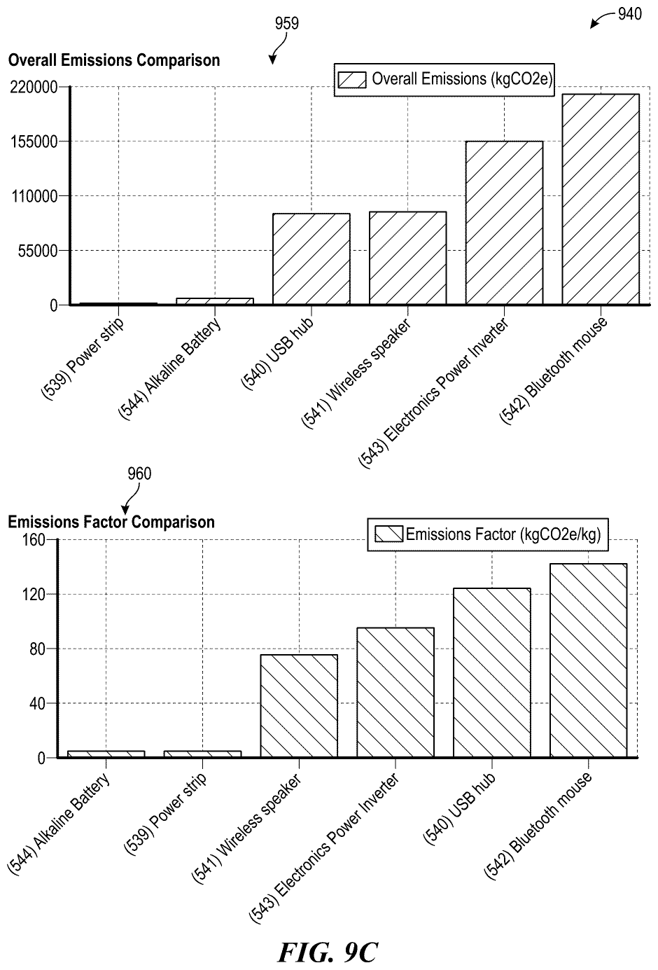

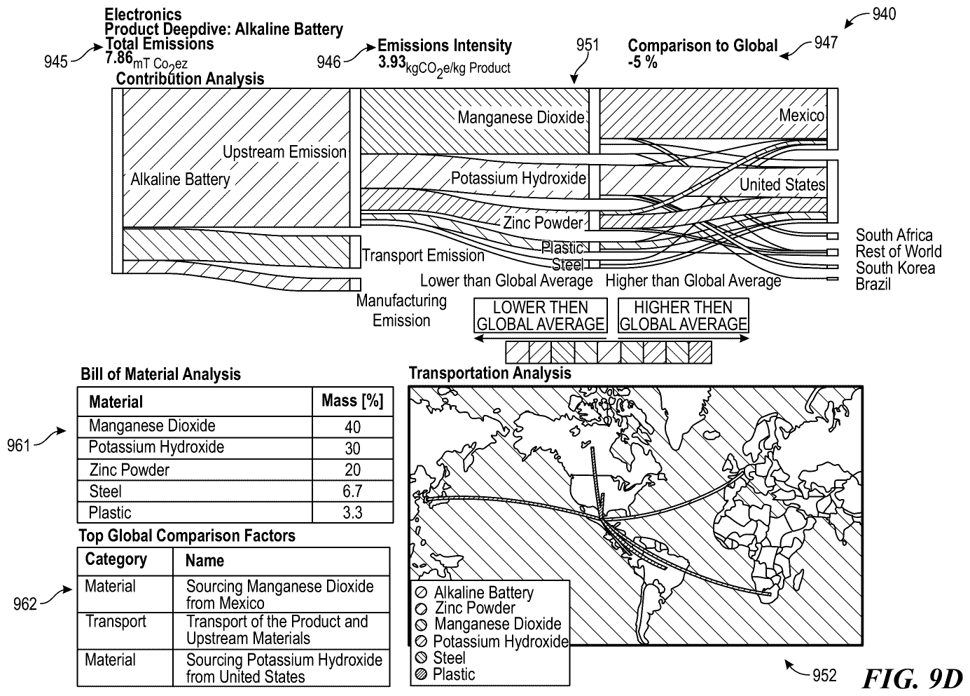

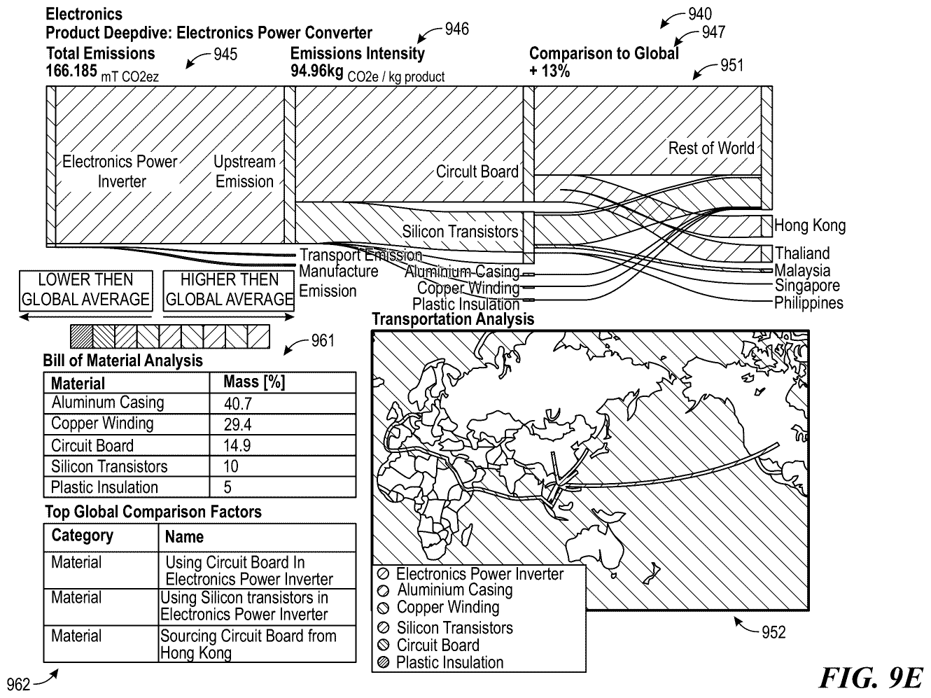

For example, FIG. 9A illustrates product inputs 910 that can be input into and analyzed by the platform 100 of FIG. 1 to generate one or more carbon footprint emissions reports in accordance with embodiments of the present technology. Multiple products are specified individually by a product description 911, a declared mass 912, a source location 913, and a destination location 914. In the illustrated embodiment, the products comprise (i) 2000 kg of alkaline batteries to be manufactured by a supplier in Mexico and shipped to India, (ii) 1500 kg of Bluetooth mice to be manufactured by a supplier in China and shipped to India, (iii) 1750 kg of electronics power inverters to be manufactured by a supplier in Vietnam and shipped to Berlin, Germany, (iv) 500 kg of power strips to be manufactured by a supplier in China and shipped to the United States, (v) 750 kg of USB hubs to be manufactured by a supplier in China and shipped to the United States, and (vi) 1250 kg of wireless speakers to be manufactured by a supplier in the United States and shipped to Guatemala.

FIGS. 9B-9E are screenshots of different portions, pages, and/or displays of a user interface 940 of the user application 102 of the platform 100 of FIG. 1 and displaying various emissions reports for the product inputs 910 of FIG. 9A in accordance with embodiments of the present technology. FIG. 9B illustrates the display of an emissions report on the user interface 940 that aggregates the emission data for the multiple products shown in FIG. 9A. The emissions report can have some features generally similar or identical to the emissions report described in detail above with reference to FIG. 8B. For example, in the illustrated embodiment the emissions report includes an aggregate total emissions value 945 for the cradle-to-gate life cycles of six products, an aggregate emissions factor value 946 for the cradle-to-gate life cycles of six products (e.g., a weighted average of the emissions factors for the individual products), and an aggregate comparison to global value 947 for the cradle-to-gate life cycles of six products (e.g., a weighted average of the comparison-to-global values for the individual products). The emissions report can further include various graphs, charts, mappings, and/or graphics breaking down the emissions, such as an aggregate sourcing country emission breakdown 948, an aggregate raw material emission breakdown 949, and an aggregate tier emission breakdown 950.

In the illustrated embodiment, the emissions report further includes carbon impact potential scores 958. The carbon impact potential scores 958 can include scores for each product and rank order the products based on the scores. In some embodiments, the scores are on a scale of 1-5, with a higher number indicating a greater opportunity to reduce emissions for the given product. For example, in the illustrated embodiment the electronics power inverter has a score of 4.2 and the wireless speaker has a score of 2.6—indicating that there is a greater opportunity to reduce emissions for the given product by making changes in the supply chain. The scores can be calculated, for example, by weighting the comparison to global values and total emission values for the individual products, with products having a greater than global average emissions and greater total emissions value being assigned a greater score.

FIG. 9C illustrates the display of an emissions report on the user interface 940 including a first graph 959 (e.g., a bar graph) comparing the total emissions for each individual product and a second graph 960 (e.g., a bar graph) comparing the emissions factor for each individual product. In the illustrated embodiment, the first graph 959 indicates that the total emissions for the products in the order from smallest to largest are: the power strip, the alkaline battery, the USB hub, the wireless speaker, the electronics power inverter, and the Bluetooth mouse. However, because the products have different masses as shown in FIG. 9A, the second graph 960 can indicate that the emissions factors for the products (i.e., averaged per unit mass, 1 kg) in the order from smallest to largest are: the alkaline battery, the power strip, the wireless speaker, the electronics power inverter, the USB hub, and the Bluetooth mouse.

FIGS. 9D and 9E illustrate the display of emissions reports on the user interface 940 that provide specific information on an individual one of the products (e.g., a “product deep dive”), such as the alkaline battery and electronics power converter, respectively. Referring to FIGS. 9D and 9E, the emissions reports can have some features generally similar or identical to the emissions reports described in detail above with reference to FIGS. 8B and 9C. For example, in the illustrated embodiment the emissions reports each include a total emissions value 945 for the cradle-to-gate life cycle of the specific product, an emissions factor value 946 (e.g., emissions intensity) for the cradle-to-gate life cycle of the specific product, a comparison to global value 947 for the cradle-to-gate life cycle of the specific product, a contribution analysis 951, and a transportation analysis 952.

In the illustrated embodiments, the emissions reports each further include a bill of material analysis 961 and a top global comparison factors analysis 962. The bill of material analysis 961 can provide a breakdown of the individual materials/components of the product and their corresponding mass percentages within the product. In some embodiments, the materials/components and masses can be determined by the product decomposer 257, as described in detail above with reference to FIGS. 2-4. The top global comparison factors analysis 962 can indicate the factors that have the greatest impact on the global comparison value 947, as described in detail above with reference to FIG. 8C.

### III. SELECTED EMBODIMENTS OF CARBON EMISSIONS RECOMMENDATION SYSTEMS AND METHODS

Referring to FIG. 1, the carbon emissions intelligence platform 104 can utilize data from the databases 106, the product inputs 110, emissions outputs from the processes 250-266 of FIG. 2, and one or more artificial intelligence (AI) applications to generate the emissions recommendations 130. The emissions recommendations 130 can comprise recommendations for changing some or all of the product inputs 110 to reduce carbon emissions. More specifically, the emissions recommendations 130 can comprise (i) the one or more sourcing locations 131, (ii) the one or more upstream sourcing locations 132, (iii) the one or more material types 133 (e.g., different materials, or recycled content of the same material), (iv) the one or more manufacturing processes 134, and/or (v) the one or more transport modes, routes, or vessels 135. Such emissions recommendations 130 can be presented at the user application 102 as text lists, graphs, flow charts, and/or other visual indicators.

Referring to FIGS. 1 and 2, in some embodiments the carbon emissions intelligence platform 104 can generate the emissions recommendations 130 by rerunning all or a portion of the processes 250-265 of FIG. 2 with different product inputs to calculate different emissions outputs, comparing the different emissions outputs to the calculated emissions outputs 120 for the specified product to determine if the different emissions outputs are less than the calculated emissions outputs 120, and returning the different product inputs as the emissions recommendations 130 if the different emissions outputs are less than the calculated emissions outputs 120 (e.g., by a threshold amount). That is, the carbon emissions intelligence platform 104 can determine alternates inputs that generate reduced carbon emissions. Table 1 below provides a detailed overview of potential emissions recommendations 130 and their implementation.

TABLE 1

| | Components of | | |
|---|---|---|---|
| | Carbon emissions | | |
| | intelligence platform | How Recommendations | |
| Recommendation | 104 to be Rerun or | (e.g., Alternates) | Further |
| Type | Partially Rerun | are Determined | Considerations |
| Sourcing | Supply chain | The product emissions | The carbon emissions |
| locations | mapper 256 | estimator 258 can consider | intelligence platform |
| 131 | Product emissions | other likely sourcing | 104 can only consider |
| | estimator 258 | countries (e.g., supplier | alternate sourcing |
| | Transport | countries). Such likely | countries having |
| | emissions | sourcing countries can be | emissions factors |
| | estimator 263 | determined via the trade | and/or transport |
| | Output aggregator | modeling databases 142. | emissions factors |
| | 265 | | below a threshold |
| | | | amount. |
| Upstream | Supply chain | The product emissions | |
| sourcing | mapper 256 | estimator 258 can consider | |
| locations | (partial rerun to | other likely upstream | |
| 132 | specify upstream | sourcing countries (e.g., | |
| | sourcing | supplier countries). Such | |
| | locations) | likely upstream sourcing | |
| | Product emissions | countries can be | |
| | estimator 258 | determined via the trade | |
| | Transport | modeling databases 142. | |
| | emissions | | |
| | estimator 263 | | |
| | Output aggregator | | |
| | 265 | | |
| Material | Supply chain | The product decomposer | The carbon emissions |
| types 133 | mapper 256 | 257 can utilize an artificial | intelligence platform |
| | (partial rerun to | intelligence (AI) | 104 can consider |
| | specify one or | application to determine | functional units when |
| | more different | likely alternate materials | determining material |
| | material types for | that can be used in, for | substitutions. For |
| | the identified | example, one or more | example, a reference |
| | nodes) | nodes identified by the | dataset can include |
| | Product emissions | product decomposer 257. | [material, |
| | estimator 258 | For example, the AI | Optional(use), |
| | Transport | application can be a | functional unit, |
| | emissions | generative AI application | functional unit per |
| | estimator 263 | in which a text prompt can | mass], and the carbon |
| | Output aggregator | be input to determine likely | emissions intelligence |
| | 265 | alternate materials from a | platform 104 can |
| | | dataset of material | select an alternate |
| | | substitutions and/or | material and its mass |
| | | product trade codes. | based on the |
| | | | functional unit |
| | | | comparison with the |
| | | | base material. |
| | | | Recyclability and |
| | | | durability can be |
| | | | noted to the user |
| | | | when suggesting |
| | | | material substitutions. |
| Material | None | The carbon emissions | The carbon emissions |
| types 133 | | intelligence platform 104 | intelligence platform |
| (product | | can utilize an artificial | 104 can consider |
| breakdown | | intelligence (AI) | functional units as |
| (material | | application to determine | described in the entry |
| percentages)) | | likely alternate materials | above. |
| | | already existing in the | |
| | | product that can be used in, | |
| | | for example, one or more | |
| | | nodes identified by the | |
| | | product decomposer 257. | |
| | | For example, the AI | |
| | | application can be a | |
| | | generative AI application | |
| | | in which a text prompt can | |
| | | be input to determine likely | |
| | | alternate materials from a | |
| | | dataset of material | |
| | | substitutions and/or | |
| | | product trade codes. | |
| | | Alternate materials can | |
| | | include recycled materials | |
| | | of the same type as the | |
| | | original material. | |
| | | That is, the carbon | |
| | | emissions intelligence | |
| | | platform 104 can make | |
| | | recommendations for | |
| | | substituting one part of the | |
| | | product for another | |
| | | material already in the | |
| | | product. | |
| Manufacturing | Product emissions | The product emissions | This recommendation |
| processes | estimator 258 | estimator 258 can match | can be specific to |
| 134 (for | Output aggregator | one or more processing | different industries. |
| product or | 265 | nodes of the product to an | The databases 106 |
| upstream | | alternate manufacturing | can include data |
| material) | | process at block 259 by, | about different |
| | | for example, utilizing an | industry types, and |
| | | artificial intelligence (AI) | particularly low- |
| | | application to determine | emitting |
| | | likely alternate | manufacturing |
| | | manufacturing processes. | processes as extracted |
| | | For example, the AI | from, for example, |
| | | application can be a | the open-source |
| | | generative AI application | openLCA database. |
| | | in which a text prompt can | |
| | | be input to determine likely | |
| | | alternate manufacturing | |
| | | processes from a dataset of | |
| | | manufacturing process | |
| | | substitutions and/or | |
| | | product trade codes. | |
| Manufacturing | None | The product emissions | |
| processes 134 | | estimator 258 can, at block | |
| (change energy | | 262 adjust the energy | |
| source of the | | source for manufacturing | |
| manufacturing | | to a lower-emitting option | |
| location) | | (e.g., solar, wind, natural | |
| | | gas). | |
| Transport | Transport | The transport emissions | Users may be able to |
| modes 135 | emissions | estimator 263 can | control the mode of |
| (sea, air, | estimator 263 | determine the most likely | transport of the final |
| road, rail) | (partial rerun of | routes and select the one | product rather than |
| | likely routes) | with the lowest emissions | the constituent |
| | | factor, or compute a low- | materials and |
| | | emission default (e.g., | components that are |
| | | sea + truck). | sourced from |
| | | | upstream suppliers. |
| Transport | None | The transport emissions | |
| modes 135 | | estimator 263 can access a | |
| (vehicle's | | dataset on likely cargo | |
| emissions | | vehicles to be used on a | |
| factor) | | given route and | |
| | | recommend those with | |
| | | fewer emissions (e.g., | |
| | | (large vs. small container | |
| | | ship, airplane type, truck | |
| | | vs. van, etc.) | |

### IV. SELECTED EMBODIMENTS OF PRODUCT DECOMPOSITION SYSTEMS AND METHODS

Referring to FIGS. 1 and 2, in some embodiments the carbon emissions intelligence platform 104 and/or another component of the platform can be configured to receive an input product, utilize an artificial intelligence (AI) application to break the product down into its constituent components and/or materials, and to present an output graphic at the user application 102 indicating the product breakdown. For example, the product decomposer 257 can recursively prompt the AI application to (i) break down the input product into a plurality of first nodes and their relative weights, (ii) break down the first nodes into a plurality of second nodes and their relative weights, (iii) break down the second nodes into a plurality of third nodes and their relative weights, (iv) and so on. The AI application can determine when to end the breakdown of a given node when, for example, the node comprises a single material or component. Alternatively or additionally, the AI application can end the breakdown at a given tier or level (e.g., at the level of the second nodes). Additionally, the AI application can map the product components and/or materials to likely sourcing countries. For example, the supply chain mapper 256 can recursively map the sourcing country by (i) determining the likely sourcing locations for each component and/or material in the first tier, (ii) determining the likely sourcing locations for each component and/or material in the second tier based on the sourcing locations of the associated node in the first tier, (iii) and so on as, for example, described in detail with reference to FIG. 5. Combining the component and/or material information and sourcing information can help users understand the impacts of import and/or export restrictions on their products and procurements.

More specifically, for example, FIG. 10 is a screenshot of a portion, a page, and/or a display of a user interface 1040 of the user application 102 of the platform 100 of FIG. 1 in accordance with embodiments of the present technology. In the illustrated embodiment, the user interface 1040 displays a product breakdown graphic 1040 for a specified input product—an inertial measurement unit for consumer electronics. The product breakdown graphic 1040 can be a Sankey diagram or other graphic illustrating the relative masses of the constituent parts of the inertial measurement unit as determined by the product decomposer 257 (FIG. 2) utilizing the AI application. In the illustrated embodiment, the product breakdown graphic 1040 illustrates the initial product (e.g., a primary node, the inertial measurement unit for consumer electronics) at a first graph portion 1064. The product breakdown graphic 1040 further illustrates a plurality of first nodes of the product decomposition (e.g., a circuit board, an accelerometer sensor, a gyroscope sensor, and a magnetometer sensor) at second graph portions 1065. The relative sizes of the second graph portions 1065 can represent the respective mass contributions of the first nodes and can account for either the mass contribution of the final product or amount of material that is needed to construct the final product by including waste. The product breakdown graphic 1040 further illustrates a plurality of second nodes of the product decomposition (e.g., a printed circuit board (PCB), copper foil, silicon chips, solder, plastic, silicon chip, plastic casing, copper wire, silicon, copper wire, plastic casing, gold plating, aluminum oxide, plastic housing, magnetic field sensor chip, copper wire, and silicon substrate) at third graph portions 1066. The relative sizes of the third graph portions 1066 can represent the respective mass contributions of the second nodes.

Referring to FIGS. 1, 2, and 10, in some embodiments the products emissions estimator 258 and/or another component of the platform 100 can use an artificial intelligence (AI) application (e.g., a generative AI application, a generative AI model, a machine learning (ML) model, a large language model (LLM), and/or the like) to convert/map the first nodes (e.g., identified at second graph portions 1065), the second nodes (e.g., identified at third graph portions 1066), and/or further nodes of the product decomposition to a product trade code, such as an HTS or HS code. The databases 106 can further comprise one or more pricing databases that contain information about commodity market prices of components, materials, labor prices, and/or energy prices, etc., based on industry classification code or component/material name and/or description. The market prices can comprise an average cost based on country. The AI application can query the pricing databases to generate a per-node (e.g., per-component or per-material) price breakdown of the product (e.g., the inertial measurement unit).

Prices may be based on country or region, and the supply chain mapper 256 can be used to map the components and/or materials to likely sourcing countries to provide more accurate prices. Component and/or material pricing information can be used as a factor in the carbon emissions intelligence platform 104 to generate the emissions recommendations 1 FIG. 6b30, to help identify reduction opportunities that have other incentives such as reducing cost. Combining the pricing and carbon emissions data can help users make more informed procurement decisions, considering both cost and carbon.

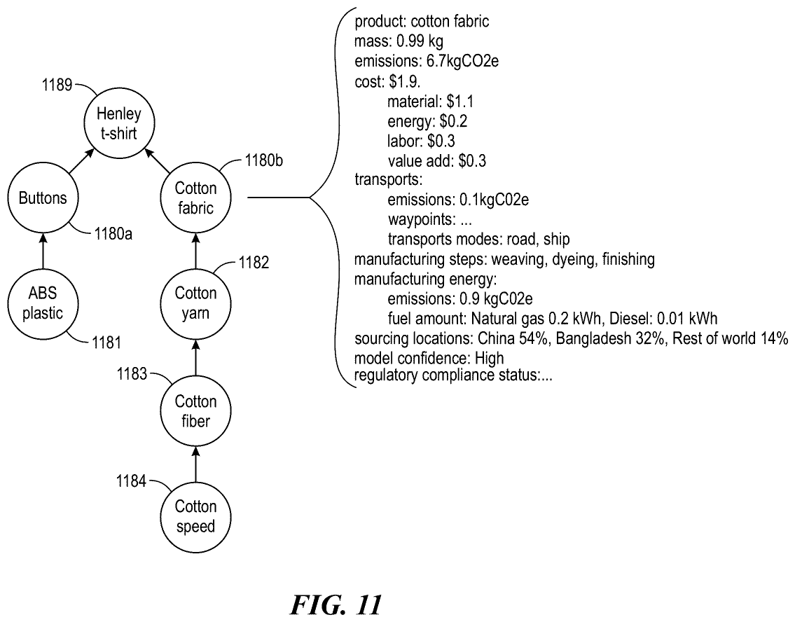

FIG. 11 shows a schematic view of an additional or alternative decomposition of the example Henley T-shirt product in accordance with embodiments of the present technology. In the illustrated embodiment, the Henley T-shirt can be iteratively/recursively broken down into multiple-tiers of nodes by, for example, the product decomposer 257 (and/or from the BoM input determined at block 253). The nodes can represent only physical materials or components of the final product (“Henley t-shirt”) (and not manufacturing processes as shown in FIG. 3B). For example, the specified product (“Henley t-shirt) comprises a primary node 1189, which is decomposed by the AI application into first nodes 1180 (including individually identified first nodes 1180a and 1180b) of components and/or materials. In the illustrated embodiment, the first node 1180a comprises “buttons” and the second node 1180b comprises “cotton fabric.” The first node 1180a can be further decomposed into, for example, a second node 1181 (e.g., “ABS plastic”). The second node 1180b can likewise be further decomposed into a second node 1182 (e.g., “cotton yarn”), the second node 1182 can be further decomposed into a third node 1183 (e.g., “cotton fiber”), the third node 1183 can be further decomposed into a fourth node 1184 (e.g., “cotton seed”), and so on.

The carbon emissions intelligence platform 104 and/or another component of the platform can be configured to generate and/or retrieve information associated with each node in the manners described above. For example, as shown with respect to the second node 1180b, each of the nodes can be matched to (i) a product type, (ii) product mass based on the declared mass of the input product (e.g., Henley t-shirt), (iii) overall emissions and/or emissions factors, (iv) a cost based on material type, manufacturing energy, and labor, (v) a transport breakdown including transport-based emissions, transport modes, etc., (vi) the manufacturing steps associated with the node, (vii) a manufacturing energy breakdown including emissions and fuel types, (viii) likely sourcing locations, and/or (ix) a confidence level for the node. Accordingly, in some aspects of the present technology the carbon emissions intelligence platform 104 provides a product decomposition into physical nodes and associates key attributes related to cost, emissions, manufacturing, etc., with each node. The decomposition and nodes can be presented to a user as shown in, for example, FIG. 10.

More specifically regarding cost, the methods and techniques described above with reference to FIGS. 2-7 can be applied to match nodes to corresponding cost factors in the same or a similar manner as described in detail with reference to emissions factors. For example, referring to FIG. 4, the product decomposer 257 can match products to entries in a cost factor database (e.g., the cost factor database 146 of FIG. 1) as part of the product decomposition. Likewise, referring to FIG. 7, the platform 100 can calculate cost factors for each node (e.g., on a per-node basis) based on the likely transport modes and distances, weight the calculated cost factors based on the supply chain mapping, and aggregate the weighted cost factors.

Referring to FIGS. 1, 2, and 10, in some embodiments the products emissions estimator 258 and/or another component of the platform 100 can use an artificial intelligence (AI) application (e.g., a generative AI application, a generative AI model, a machine learning (ML) model, a large language model (LLM), and/or the like) to convert/map the first nodes (e.g., identified at second graph portions 1065 in FIG. 10), the second nodes (e.g., identified at third graph portions 1066 in FIG. 10), and/or further nodes of the product decomposition to other databases classified by material, component, industry classification code, and/or trade classification code. For example, the databases 106 can further comprise one or more regulatory compliance databases, wherein such databases may include critical mineral classification databases, chemical restriction databases (including but not limited to per- and polyfluoroalkyl substances (PFAS) databases), material declaration databases, substance of concern databases, and/or environmental impact databases. The regulatory compliance databases can comprise a classification of materials by country or based on country (e.g., a material sourced from China may be classified differently than a material sourced from another country). The AI application can query the regulatory compliance databases to generate a per-node (e.g., per-component or per-material) flagging for regulatory compliance of the product (e.g., the inertial measurement unit).

### V. SELECTED EMBODIMENTS OF OVERALL SYSTEMS AND METHODS

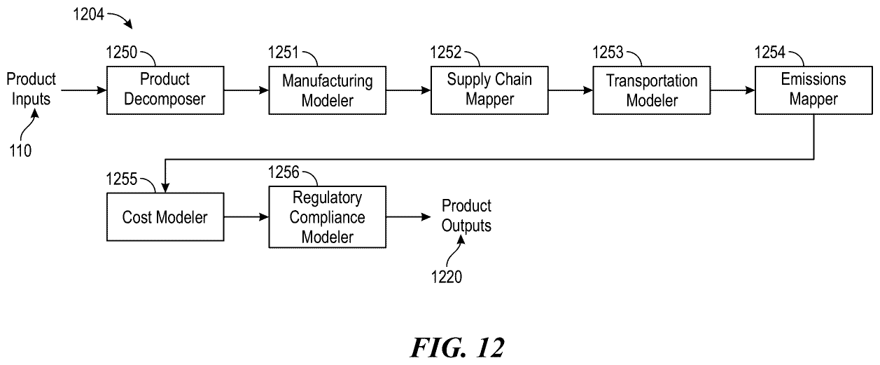

Although many aspects of the present technology are described with reference to systems and methods for generating carbon emissions estimates for a given product, the systems and methods of the present technology can generate/calculate additional pertinent attributes about a product in addition to or alternatively to carbon emissions. FIG. 12, for example, is a block diagram of a product intelligence platform 1204 in accordance with embodiments of the present technology. The product intelligence platform 1204 can interface with the user application 102 and the databases 106 shown in FIG. 1, and can have many features similar or identical to the carbon emissions platform 104 described in detail above, and can operate in a similar or identical manner.

In the illustrated embodiment, the product intelligence platform 1204 includes a product decomposer 1250, a manufacturing modeler 1251, a supply chain mapper 1252, a transportation modeler 1253, an emissions mapper 1254, a cost modeler 1255, and a regulatory compliance modeler 1256. The product decomposer 1250 receives the product inputs 110. The product decomposer 1250 can decompose the input product specified by the product inputs 110 in a hierarchical manner into its constituent components and materials and their amounts as, for example, described in detail above with reference to the product input validator 250, the BoM validator 254, the product decomposer 257, the manufacturing process generator 266, and/or the like described in detail above with reference to FIG. 2. Starting at the product level (Tier 0; primary node), the product decomposer 1250 can automatically break down the product into all necessary component and material inputs into the manufacturing process to make the product and their amounts (Tier 1 components; secondary nodes). After this first level breakdown, the product decomposer 1250 can then break down each tier 1 component into its components and materials and their amounts (Tier 2 components; tertiary nodes). This process can continue until a suitable product model has been generated. Each generated component or material is considered a “node” in the model as, for example, described in detail above with reference to FIG. 11. As one specific example, for a product of a tri-blend t-shirt (Tier 0), the product decomposer 1250 may generate a breakdown at Tier 1 of: polyester (0.44 kg), cotton (0.24 kg), rayon (0.24 kg), polyester thread (0.01 kg), fabric dye (0.08 kg).

The manufacturing modeler 1251 can receive the nodes of the decomposed product from the product decomposer 1250 and generate a list of steps necessary to manufacture each node as, for example, described in detail above with reference to the manufacturing process generator 266 of FIG. 2. For example, for a node that has been broken down (e.g., the Tier 0 Product node), the manufacturing modeler 1251 can analyze the components and materials that have been determined to be input to the manufacturing process, evaluate common manufacturing processes to construct the relevant product/component/material, and then generate a list of steps necessary to manufacture the product. The manufacturing step list is used as the basis for how the product is manufactured from the input products. In the specific example of a tri-blend t-shirt, the manufacturing modeler 1251 can generate manufacturing steps such as cutting, sewing, dyeing, finishing, and/or the like.

The supply chain mapper 1252 can receive the decomposed nodes and manufacturing steps for each node and determine the likely sourcing countries for the various components and materials as, for example, described in detail above with reference to the supply chain mapper 256 of FIG. 2. For example, for each component and material broken out by the product decomposer 1250, based on the source, the supply chain mapper 1252 can determine the likely upstream sourcing countries for the component/material. To do this, the supply chain mapper 1252 can convert the component/material to an HTS Code, then import percentages by country calculated using a trade database and exports (as a proxy for domestic production). A threshold can be used as a cutoff with remaining value attributed to the rest of world (RoW). This provides a probabilistic view of the likely sourcing countries of components and materials. In the specific example of a tri-blend t-shirt, for the Tier 1 material polyester, presuming a source location of China, the sourcing country ratios may be 98% China and 2% RoW.

The transportation modeler 1253 can receive the decomposed nodes and sourcing locations and determine the transportation routes, modes, and emissions for the product and its components/materials as, for example, described in detail above with reference to the transport emissions estimator 263 of FIG. 2. For example, for the link between source location and destination location, as well as upstream links between component/material predicted source countries and their respective destination locations, the transportation modeler 1253 can calculate the most likely set of transportation modes based on the product type. For each mode, the transportation modeler 1253 can calculate the most likely intermediary waypoints (e.g., airports, ports, train stations, etc.). Finally, for each mode and waypoint set, the transportation modeler 1253 can calculate the most likely route between points. In the specific example of shipment of a tri-blend t-shirt from Shanghai, China to Seattle, Washington, the route generated may include transportation by truck from Shanghai to the Port of Shanghai, by ship to the Port of Seattle, and finally by truck to Seattle.

The emissions mapper 1254 can receive the decomposed nodes, manufacturing steps, and transport estimates, and determined estimated emissions of the product based on each as, for example, described in detail above with reference to the product emissions estimator 258 of FIG. 2. For example, for low level material nodes, the emissions mapper 1254 can determine the most applicable material/component emission factor in an emissions factor database. This can be a direct material-to-material match or, depending on coverage, a relevant proxy may be used. Proxy matching uses vector similarity scores, determining the best matching material/component in the vector database. For manufacturing nodes, the emissions mapper 1254 can determine the most applicable manufacturing emission factors for each of the manufacturing steps determined by the manufacturing modeler 1251. This can use a similar direct or proxy mapping as the previous case. For all matched emission factors, the emissions mapper 1254 can adjust the emission factor to the local grid or most likely fuel type. If the geographic location specific emission factor is available in the base dataset, then it can be used, otherwise the activity's electricity emission factor can be adjusted to the region-specific grid factor and fuel emission factor can be adjusted based on the most likely type of fuel used in the region. Finally, the emissions mapper 1254 can calculate the emissions for each transport leg based on the mode, distance, and relevant emission factors for the transport mode. As a specific example, a material node of chlorine may be directly matched to a chlorine production activity in the base database, then given the manufacturing is occurring in Mexico the electricity and fuel can be adjusted with the Mexico grid emission factor and most likely fuel type ratio (natural gas, coal, etc.) for the location, respectively.

The cost modeler 1255 can estimate a cost for the various components/materials of the product and the product overall as, for example, described in detail above with reference to FIG. 10. Similarly, the regulatory compliance modeler 1256 can estimate a regulatory compliance status for the various components/materials of the product and the product overall as, for example, described in detail above with reference to FIG. 10.

Product outputs 1220 from the product intelligence platform 1204 can accordingly include a detailed product decomposition into physical nodes and associated key attributes related to cost, emissions, manufacturing, regulatory compliance, etc., with each node. The decomposition, nodes, and attributes can be presented to a user as shown in, for example, FIGS. 8A-10. In some embodiments, the product intelligence platform 1204 can include omit one or more of the emissions mapper 1254 for generating emissions estimates, the cost modeler 1255 for generating cost estimates for constituent materials/components, the regulatory compliance modeler 1256 for generating regulatory compliance status data, and/or the product intelligence platform 1204 can include one or more additional modelers that utilize an AI application to generate product attribute data associated with each node and the product overall.

### VI. SELECTED EMBODIMENTS OF COMPUTING ENVIRONMENTS

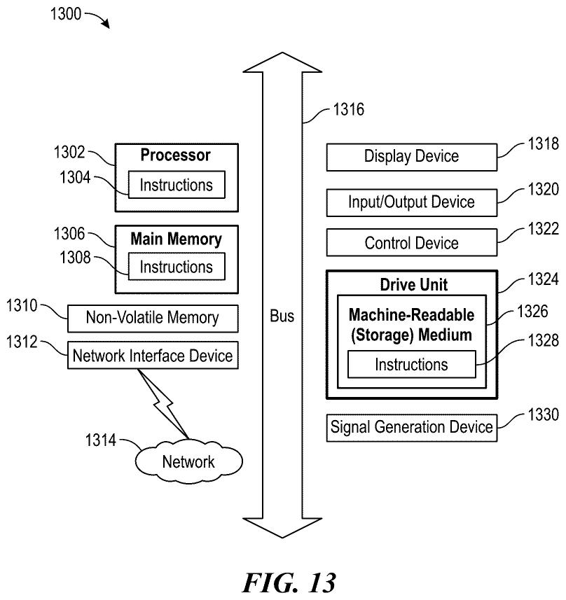

FIG. 13 is a block diagram that illustrates an example of a computer system 1300 in which at least some operations described herein can be implemented. The computer system 1300 can include: one or more processors 1302, a main memory 1306, a non-volatile memory 1310, a network interface device 1312, a display device 1318, an input/output device 1320, a control device 1322 (e.g., keyboard and pointing device), a drive unit 1324 that includes a machine readable (storage) medium 1326, and a signal generation device 1330 that are communicatively connected to a bus 1316. The bus 1316 represents one or more physical buses and/or point-to-point connections that are connected by appropriate bridges, adapters, and/or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computer system 1300 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1300. In some implementations, the computer system 1300 can be an embedded computer system, a system-on-chip (SOC), a single-board computer (SBC) system, or a distributed system such as a mesh of computer systems or include one or more cloud components in one or more networks. Where appropriate, one or more computer systems 1300 can perform operations in real time, near real time, or in batch mode.

The network interface device 1312 enables the computer system 1300 to mediate data in a network 1314 with an entity that is external to the computer system 1300 through any communication protocol supported by the computer system 1300 and the external entity. Examples of the network interface device 1312 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., the main memory 1306, the non-volatile memory 1310, the machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable medium 1326 can include any medium that is capable of storing, encoding, or carrying a set of instructions for execution by the computer system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computer system 1300 to perform operations to execute elements involving the various aspects of the disclosure.

### VII. SELECTED EMBODIMENTS OF ARTIFICIAL INTELLIGENCE AND MACHINE LEARNING IMPLEMENTATIONS

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, for example, the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, for example, having a particular architecture, having a particular training procedure, being describable by a set of model hyperparameters, and/or otherwise being varied from the other of the one or more ML models. The validation (or cross-validation) set may then be used as input data into the trained ML models to, for example, measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, for example, fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails, to identify unintelligible inputs), create content for various purposes (e.g., social media content, factual content, or marketing content), and/or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

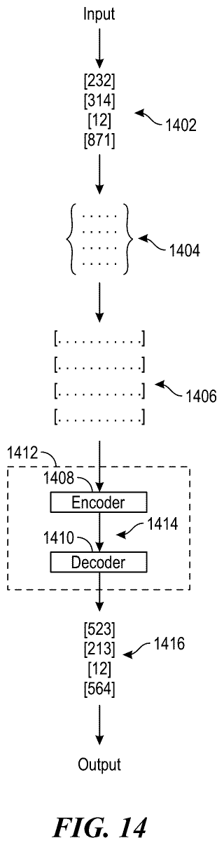

FIG. 14 is a block diagram of an example transformer 1412. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 1412 includes an encoder 1408 (which can include one or more encoder layers/blocks connected in series) and a decoder 1410 (which can include one or more decoder layers/blocks connected in series). Generally, the encoder 1408 and the decoder 1410 each include multiple neural network layers, at least one of which can be a self-attention layer. The parameters of the neural network layers can be referred to as the parameters of the language model.

The transformer 1412 can be trained to perform certain functions on a natural language input. Examples of the functions include summarizing existing content, brainstorming ideas, writing a rough draft, fixing spelling and grammar, translating content, and/or the functions attributed to various artificial intelligence (AI) applications described in detail above with reference to FIGS. 1-9E. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 1412 is trained to perform certain functions on other input formats than natural language input. For example, the input can include objects, images, audio content, or video content, or a combination thereof.

The transformer 1412 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 14 illustrates an example of how the transformer 1414 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 14, a short sequence of tokens 1402 corresponding to the input text is illustrated as input to the transformer 1412. Tokenization of the text sequence into the tokens 1402 can be performed by some pre-processing tokenization module such as, for example, a byte-pair encoding tokenizer (the “pre” referring to the tokenization occurring prior to the processing of the tokenized input by the LLM), which is not shown in FIG. 14 for brevity. In general, the token sequence that is inputted to the transformer 1412 can be of any length up to a maximum length defined based on the dimensions of the transformer 1412. Each token 1402 in the token sequence is converted into an embedding vector 1406 (also referred to as “embedding 1406”).

An embedding 1406 is a learned numerical representation (such as, for example, a vector) of a token that captures some semantic meaning of the text segment represented by the token 1402. The embedding 1406 represents the text segment corresponding to the token 1402 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1406 corresponding to the “write” token will be closer to another embedding corresponding to the “jot down” token in the vector space as compared to the distance between the embedding 1406 corresponding to the “write” token and another embedding corresponding to the “summary” token.

The vector space can be defined by the dimensions and values of the embedding vectors. Various techniques can be used to convert a token 1402 to an embedding 1406. For example, another trained ML model can be used to convert the token 1402 into an embedding 1406. In particular, another trained ML model can be used to convert the token 1402 into an embedding 1406 in a way that encodes additional information into the embedding 1406 (e.g., a trained ML model can encode positional information about the position of the token 1402 in the text sequence into the embedding 206). In some implementations, the numerical value of the token 1402 can be used to look up the corresponding embedding in an embedding matrix 1404, which can be learned during training of the transformer 1412.

The generated embeddings 1406 are input into the encoder 1408. The encoder 1408 serves to encode the embeddings 1406 into feature vectors 1414 that represent the latent features of the embeddings 1406. The encoder 1408 can encode positional information (i.e., information about the sequence of the input) in the feature vectors 1414. The feature vectors 1414 can have very high dimensionality (e.g., on the order of thousands or tens of thousands), with each element in a feature vector 1414 corresponding to a respective feature. The numerical weight of each element in a feature vector 1414 represents the importance of the corresponding feature. The space of all possible feature vectors 1414 that can be generated by the encoder 1408 can be referred to as a latent space or feature space.

Conceptually, the decoder 1410 is designed to map the features represented by the feature vectors 1414 into meaningful output, which can depend on the task that was assigned to the transformer 1412. For example, if the transformer 1412 is used for a translation task, the decoder 1410 can map the feature vectors 1414 into text output in a target language different from the language of the original tokens 1402. Generally, in a generative language model, the decoder 1410 serves to decode the feature vectors 1414 into a sequence of tokens. The decoder 1410 can generate output tokens 1416 one by one. Each output token 1416 can be fed back as input to the decoder 1410 in order to generate the next output token 1416. By feeding back the generated output and applying self-attention, the decoder 1410 can generate a sequence of output tokens 1416 that has sequential meaning (e.g., the resulting output text sequence is understandable as a sentence and obeys grammatical rules). The decoder 1410 can generate output tokens 1416 until a special [EOT] token (indicating the end of the text) is generated. The resulting sequence of output tokens 1416 can then be converted to a text sequence in post-processing. For example, each output token 1416 can be an integer number that corresponds to a vocabulary index. By looking up the text segment using the vocabulary index, the text segment corresponding to each output token 1416 can be retrieved, the text segments can be concatenated together, and the final output text sequence can be obtained.

In some implementations, the input provided to the transformer 1412 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

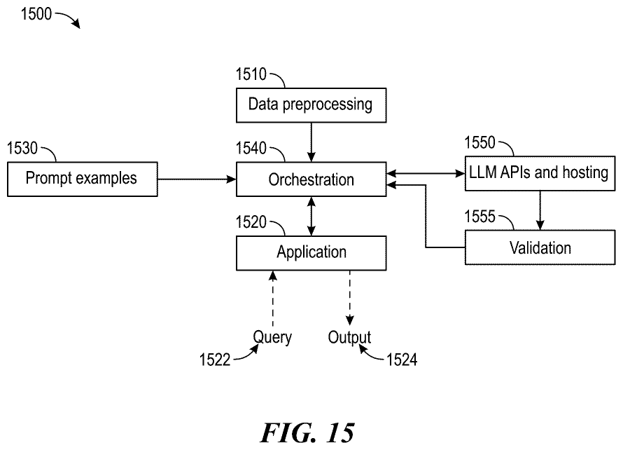

FIG. 15 is a block diagram illustrating an architecture 1500 for LLM applications, according to some implementations. As shown in FIG. 15, the architecture 1500 can include a data preprocessing block 1510, an application 1520, a prompt examples block 1530, an orchestration block 1540, an LLM APIs and Hosting block 1550, and a validation block 1555. Other implementations of the architecture 1500 can include additional, fewer, or different components, or can distribute functionality differently among the components.

The data preprocessing block 1510 manages contextual data and embeddings that can be used to train LLMs or to serve as a data source for an LLM to generate an output. Contextual data can include documents in any of a variety of formats, including text, PDFs, SQL tables, CSV files, images, or code repositories. The data preprocessing block 1510 can retrieve the contextual data from publicly available sources, private sources associated with the application 1520, or a combination of public and private sources.

The data preprocessing block 1510 can generate embeddings of the contextual data or invoke a service to generate the embeddings. The models used to generate embeddings can be trained for the specific model or application in which the embeddings are to be used. Embeddings can be stored in a vector database.

An application 1520 interfaces between a user or external system and the architecture of the LLM. A query 1522 can be input at the application 1520. Based on the query, the application 1520 generates a prompt or series of prompts to cause the LLM to produce a specified output. The application 1520 returns outputs 1524 from the LLM to the requesting user or system.

A prompt is an input to an LLM that instructs the LLM to generate a desired output. Prompts can be structured as a natural language input that includes elements of a user query, hardcoded or dynamically generated prompts templates, data retrieved from external sources at the time the prompt is generated, or other elements that provide contextual data, specific instructions, or validation requirements for the LLM. A computing system, such as the application 1520, generates a prompt that is provided as input to the LLM via the LLM's API. As described above, the prompt may optionally be processed or pre-processed into a token sequence prior to being provided as input to the LLM.

Some prompts can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples can be referred to as a zero-shot prompt. The prompt examples block 1530 provides these example outputs to the LLM for one-shot or few-shot prompts. Example outputs can be provided to the prompt examples block 1530 by a user or developer of the application 1520, in some cases.

The orchestration block 1540 interfaces between LLM application programming interfaces (APIs), the data preprocessing block 1510, the application 1520, the prompt examples block 1530, and/or other data sources or systems. The orchestration block 1540 can submits prompts received from the application 1520 to the LLM. In some implementations, the orchestration block 1540 causes the prompt to be pre-processed into a token sequence prior to being provided as input to the LLM. The orchestration block 1540 can also process prompts to prioritize embeddings that are more relevant to produce a particular output from the LLM or to reorder prompts or embeddings to enable the LLM to produce a contextually relevant response.

The validation block 1555 validates outputs from the LLM before providing the outputs to the requesting application 1520.

### VIII. EXAMPLES

The following examples are illustrative of several embodiments of the present technology:

1. A method of generating a cost estimate and/or an emissions output for a physical product, the method comprising:
receiving inputs specifying the product, wherein the inputs comprise (a) a name of product, (b) a source location where the product is to be sourced, and (c) a destination location where the product is to be received;
inputting the name of the product into a first artificial intelligence (AI) application and utilizing the first AI application to decompose the product into a plurality of nodes, wherein each node comprises a constituent material and/or component of the product;
inputting each of the nodes into a second AI application and utilizing the second AI application to generate at least one manufacturing step used to manufacture each node;
inputting each of the nodes and the source location into a third AI application and utilizing the third AI application to generate a probabilistic supply chain mapping of each node from likely upstream source locations to the source location;
inputting each of the nodes, the probabilistic supply chain mapping, the source location, and the destination location into a fourth AI application and utilizing the fourth AI application to generate likely transportation modes and routes for (a) each node from the likely upstream sources locations to the source location and (b) the product from the source location to the destination location;
generating the cost estimate for the product and/or the emissions output for the product based on the nodes, the manufacturing steps, and the likely transportation modes and routes; and
outputting at least a portion of the cost estimate for the product and/or the emissions output for the product to a user interface.

2. The method of example 1 wherein the method further comprises:
matching each of the nodes and the manufacturing steps to at least one database of emissions factors; and
extracting an emission factor for each of the nodes and the manufacturing steps from the at least one database of emissions factors.

3. The method of example 2 wherein the method further comprises adjusting the emissions factors based on the probabilistic supply chain mapping.

4. The method of any one of examples 1-3 wherein the method further comprises:
generating emissions factors for each of the likely transportation modes and routes; and
weighting the generated emissions factors for each of the likely transportation modes and routes based on the probabilistic supply chain mapping.

5. The method of any one of examples 1˜4 wherein the method further comprises:
matching each of the nodes and the manufacturing steps to at least one database of emissions factors;
extracting an emission factor for each of the nodes and the manufacturing steps from the at least one database of emissions factors;
adjusting the emissions factors based on the probabilistic supply chain mapping;
aggregating the adjusted emissions factors and the weighted emissions factors to generate the emissions output for the product; and
outputting at least a portion of the emissions output for the product to the user interface.

6. The method of any one of examples 1-5 wherein the method further comprises:
matching each of the nodes and the manufacturing steps to at least one database of cost factors; and
extracting a cost factor for each of the modes and the manufacturing steps from the at least database of cost factors.

7. The method of example 6 wherein the method further comprises adjusting the cost factors based on the probabilistic supply chain mapping.

8. The method of any one of examples 1-7 wherein the method further comprises:
generating cost factors for each of the likely transportation modes and routes; and
weighting the cost factors for each of the likely transportation modes and routes based on the probabilistic supply chain mapping.

9. The method of example 8 wherein the method further comprises adjusting the cost factors based on the probabilistic supply chain mapping.

10. The method of any one of examples 1-9 wherein the method further comprises:
matching each of the nodes and the manufacturing steps to at least one database of cost factors;
extracting a cost factor for each of the nodes and the manufacturing steps from the at least one database of cost factors;
adjusting the cost factors based on the probabilistic supply chain mapping;
aggregating the adjusted cost factors and the weighted cost factors to generate the cost output for the product; and
outputting at least a portion of the cost output for the product to the user interface.

11. The method of any one of examples 1-10 wherein the method further comprises displaying the at least portion of the cost estimate for the product and/or the emissions output for the product as a Sankey diagram on a user display.

12. The method of example 11 wherein the Sankey diagram displays flows of cost and/or emissions between each of the nodes.

13. The method of any one of examples 1-12 wherein utilizing the third AI application to generate the probabilistic supply chain mapping comprises, for individual ones of the nodes:
converting the node to a product trade code;
determining total imports of the product trade code to the source country from foreign countries based on at least one trade modeling database;
determining total exports of the product trade code from the source country based on the at least one trade modeling database; and
weighting contributions of the total imports and total exports on a per-country basis to generate the probabilistic supply chain mapping.

14. The method of example 13 wherein utilizing the third AI application to generate the probabilistic supply chain mapping further comprises, for individual ones of the nodes:
applying a threshold hold cutoff to the weighted contributions; and
allocating contributions from countries beneath the threshold to rest of world.

15. A system for generating a cost estimate and/or an emissions output for a physical product, the system comprising:
a processor; and
a non-transitory computer readable medium storing instructions that, when executed by the processor, cause the processor to—
   receive inputs specifying the product, wherein the inputs comprise (a) a name of product, (b) a source location where the product is to be sourced, and (c) a destination location where the product is to be received;
   input the name of the product into a first artificial intelligence (AI) application and utilizing the first AI application to decompose the product into a plurality of nodes, wherein each node comprises a constituent material and/or component of the product;
   input each of the nodes into a second AI application and utilizing the second AI application to generate at least one manufacturing step used to manufacture each node;
   input each of the nodes and the source location into a third AI application and utilizing the third AI application to generate a probabilistic supply chain mapping of each node from likely upstream source locations to the source location;
   input each of the nodes, the probabilistic supply chain mapping, the source location, and the destination location into a fourth AI application and utilizing the fourth AI application to generate likely transportation modes and routes for (a) each node from the likely upstream sources locations to the source location and (b) the product from the source location to the destination location;
   generate the cost estimate for the product and/or the emissions output for the product based on the nodes, the manufacturing steps, and the likely transportation modes and routes; and
   output at least a portion of the cost estimate for the product and/or the emissions output for the product to the user interface.

16. The system of example 15 wherein the instructions, when executed by the processor, further cause the processor to:
match each of the nodes and the manufacturing steps to at least one database of emissions factors;
extract an emission factor for each of the nodes and the manufacturing steps from the at least one database of emissions factors;
adjust the emissions factors based on the probabilistic supply chain mapping;
aggregate the adjusted emissions factors and the weighted emissions factors to generate the emissions output for the product; and
output at least a portion of the emissions output for the product to the user interface.

17. The system of example 16 wherein the instructions, when executed by the processor, further cause the processor to utilize the third AI application to generate the probabilistic supply chain mapping by, for individual ones of the nodes:
converting the node to a product trade code;
determining total imports of the product trade code to the source country from foreign countries based on at least one trade modeling database;
determining total exports of the product trade code from the source country based on the at least one trade modeling database; and
weighting contributions of the total imports and total exports on a per-country basis to generate the probabilistic supply chain mapping.

18. The system of any one of examples 15-17 wherein the instructions, when executed by the processor, further cause the processor to:
match each of the nodes and the manufacturing steps to at least one database of cost factors;
extract a cost factor for each of the nodes and the manufacturing steps from the at least one database of cost factors;
adjust the cost factors based on the probabilistic supply chain mapping;
aggregate the adjusted cost factors and the weighted cost factors to generate the cost output for the product; and
output at least a portion of the cost output for the product to the user interface.

19. The system of example 18 wherein the instructions, when executed by the processor, further cause the processor to utilize the third AI application to generate the probabilistic supply chain mapping by, for individual ones of the nodes:
converting the node to a product trade code;
determining total imports of the product trade code to the source country from foreign countries based on at least one trade modeling database;
determining total exports of the product trade code from the source country based on the at least one trade modeling database as proxy for production of the product trade code by the source location; and
weighting contributions of the total imports and total exports on a per-country basis to generate the probabilistic supply chain mapping.

20. A method of generating a carbon footprint for a product to be manufactured at a source location and transported to a destination location, the method comprising:
decomposing the product into constituent materials, components, and/or processes;
matching the constituent materials, components, and/or processes to at least one database of emission factors;
extracting the emissions factors for the constituent materials, components, and/or processes;
generating a probabilistic supply chain mapping of the constituent materials and/or components from upstream source locations to the source location;
adjusting the emissions factors based on the probabilistic supply chain mapping; and
aggregating the adjusted emissions factors to generate an emissions output for the product.

### IX. CONCLUSION

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the present technology encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A method of generating a cost estimate and/or an emissions output for a physical product, the method comprising:
receiving inputs specifying the product, wherein the inputs comprise (a) a name of product, (b) a source location where the product is to be sourced, and (c) a destination location where the product is to be received;
inputting the name of the product into a first artificial intelligence (AI) application and utilizing the first AI application to decompose the product into a plurality of nodes, wherein each node comprises a constituent material and/or component of the product;
inputting each of the nodes into a second AI application and utilizing the second AI application to generate at least one manufacturing step used to manufacture each node;
inputting each of the nodes and the source location into a third AI application and utilizing the third AI application to generate a probabilistic supply chain mapping of each node from likely upstream source locations to the source location;
inputting each of the nodes, the probabilistic supply chain mapping, the source location, and the destination location into a fourth AI application and utilizing the fourth AI application to generate likely transportation modes and routes for (a) each node from the likely upstream sources locations to the source location and (b) the product from the source location to the destination location;
generating the cost estimate for the product and/or the emissions output for the product based on the nodes, the manufacturing steps, and the likely transportation modes and routes; and
outputting at least a portion of the cost estimate for the product and/or the emissions output for the product to a user interface.

2. The method of claim 1 wherein the method further comprises:
matching each of the nodes and the manufacturing steps to at least one database of emissions factors; and
extracting an emission factor for each of the nodes and the manufacturing steps from the at least one database of emissions factors.

3. The method of claim 2 wherein the method further comprises adjusting the emissions factors based on the probabilistic supply chain mapping.

4. The method of claim 1 wherein the method further comprises:
generating emissions factors for each of the likely transportation modes and routes; and
weighting the generated emissions factors for each of the likely transportation modes and routes based on the probabilistic supply chain mapping.

5. The method of claim 1 wherein the method further comprises:
matching each of the nodes and the manufacturing steps to at least one database of emissions factors;
extracting an emission factor for each of the nodes and the manufacturing steps from the at least one database of emissions factors;
adjusting the emissions factors based on the probabilistic supply chain mapping;
aggregating the adjusted emissions factors and the weighted emissions factors to generate the emissions output for the product; and
outputting at least a portion of the emissions output for the product to the user interface.

6. The method of claim 1 wherein the method further comprises:
matching each of the nodes and the manufacturing steps to at least one database of cost factors; and
extracting a cost factor for each of the modes and the manufacturing steps from the at least database of cost factors.

7. The method of claim 6 wherein the method further comprises adjusting the cost factors based on the probabilistic supply chain mapping.

8. The method of claim 1 wherein the method further comprises:
generating cost factors for each of the likely transportation modes and routes; and
weighting the cost factors for each of the likely transportation modes and routes based on the probabilistic supply chain mapping.

9. The method of claim 8 wherein the method further comprises adjusting the cost factors based on the probabilistic supply chain mapping.

10. The method of claim 1 wherein the method further comprises:
matching each of the nodes and the manufacturing steps to at least one database of cost factors;
extracting a cost factor for each of the nodes and the manufacturing steps from the at least one database of cost factors;
adjusting the cost factors based on the probabilistic supply chain mapping;
aggregating the adjusted cost factors and the weighted cost factors to generate the cost output for the product; and
outputting at least a portion of the cost output for the product to the user interface.

11. The method of claim 1 wherein the method further comprises displaying the at least portion of the cost estimate for the product and/or the emissions output for the product as a Sankey diagram on a user display.

12. The method of claim 11 wherein the Sankey diagram displays flows of cost and/or emissions between each of the nodes.

13. The method of claim 1 wherein utilizing the third AI application to generate the probabilistic supply chain mapping comprises, for individual ones of the nodes:
converting the node to a product trade code;
determining total imports of the product trade code to the source country from foreign countries based on at least one trade modeling database;
determining total exports of the product trade code from the source country based on the at least one trade modeling database; and
weighting contributions of the total imports and total exports on a per-country basis to generate the probabilistic supply chain mapping.

14. The method of claim 13 wherein utilizing the third AI application to generate the probabilistic supply chain mapping further comprises, for individual ones of the nodes:
applying a threshold hold cutoff to the weighted contributions; and
allocating contributions from countries beneath the threshold to rest of world.

15. A system for generating a cost estimate and/or an emissions output for a physical product, the system comprising:
a processor; and
a non-transitory computer readable medium storing instructions that, when executed by the processor, cause the processor to—
receive inputs specifying the product, wherein the inputs comprise (a) a name of product, (b) a source location where the product is to be sourced, and (c) a destination location where the product is to be received;
input the name of the product into a first artificial intelligence (AI) application and utilizing the first AI application to decompose the product into a plurality of nodes, wherein each node comprises a constituent material and/or component of the product;
input each of the nodes into a second AI application and utilizing the second AI application to generate at least one manufacturing step used to manufacture each node;
input each of the nodes and the source location into a third AI application and utilizing the third AI application to generate a probabilistic supply chain mapping of each node from likely upstream source locations to the source location;
input each of the nodes, the probabilistic supply chain mapping, the source location, and the destination location into a fourth AI application and utilizing the fourth AI application to generate likely transportation modes and routes for (a) each node from the likely upstream sources locations to the source location and (b) the product from the source location to the destination location;
generate the cost estimate for the product and/or the emissions output for the product based on the nodes, the manufacturing steps, and the likely transportation modes and routes; and
output at least a portion of the cost estimate for the product and/or the emissions output for the product to the user interface.

16. The system of claim 15 wherein the instructions, when executed by the processor, further cause the processor to:
match each of the nodes and the manufacturing steps to at least one database of emissions factors;
extract an emission factor for each of the nodes and the manufacturing steps from the at least one database of emissions factors;
adjust the emissions factors based on the probabilistic supply chain mapping;
aggregate the adjusted emissions factors and the weighted emissions factors to generate the emissions output for the product; and
output at least a portion of the emissions output for the product to the user interface.

17. The system of claim 16 wherein the instructions, when executed by the processor, further cause the processor to utilize the third AI application to generate the probabilistic supply chain mapping by, for individual ones of the nodes:
converting the node to a product trade code;
determining total imports of the product trade code to the source country from foreign countries based on at least one trade modeling database;
determining total exports of the product trade code from the source country based on the at least one trade modeling database; and
weighting contributions of the total imports and total exports on a per-country basis to generate the probabilistic supply chain mapping.

18. The system of claim 15 wherein the instructions, when executed by the processor, further cause the processor to:
match each of the nodes and the manufacturing steps to at least one database of cost factors;
extract a cost factor for each of the nodes and the manufacturing steps from the at least one database of cost factors;
adjust the cost factors based on the probabilistic supply chain mapping;
aggregate the adjusted cost factors and the weighted cost factors to generate the cost output for the product; and
output at least a portion of the cost output for the product to the user interface.

19. The system of claim 18 wherein the instructions, when executed by the processor, further cause the processor to utilize the third AI application to generate the probabilistic supply chain mapping by, for individual ones of the nodes:
converting the node to a product trade code;
determining total imports of the product trade code to the source country from foreign countries based on at least one trade modeling database;
determining total exports of the product trade code from the source country based on the at least one trade modeling database as proxy for production of the product trade code by the source location; and
weighting contributions of the total imports and total exports on a per-country basis to generate the probabilistic supply chain mapping.

20. A method of generating a carbon footprint for a product to be manufactured at a source location and transported to a destination location, the method comprising:
decomposing the product into constituent materials, components, and/or processes;
matching the constituent materials, components, and/or processes to at least one database of emission factors;
extracting the emissions factors for the constituent materials, components, and/or processes;
generating a probabilistic supply chain mapping of the constituent materials and/or components from upstream source locations to the source location;
adjusting the emissions factors based on the probabilistic supply chain mapping; and
aggregating the adjusted emissions factors to generate an emissions output for the product.
